(19) United States
(12) Patent Application Publication
(10) Pub. No.: US 2010/0139778 A1
(43) Pub. Date: Jun. 10, 2010

(54) Fuel vapor pressure measuring apparatus

(75) Inventors: Nobuhiro Kato, Tokai-shi (JP); Masaki Ikeya, Obu-shi (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, OBU-SHI (JP)

(21) Appl. No.: 12/591,045

(22) Filed: Nov. 5, 2009

(30) Foreign Application Priority Data
Dec. 9, 2008 (JP) 2008-313114

(51) Int. Cl. F17D 1/14; G01N 7/00

(52) U.S. Cl. 137/14; 73/64.45

(57) ABSTRACT

A fuel vapor pressure measuring apparatus includes a fuel vapor generator configured to allow the fuel pressure-fed from the fuel pump to be injected from a nozzle and pass through a venturi, thereby vaporizing the fuel in a vaporizing chamber, a pressure sensor for detecting fuel vapor pressure in the vaporizing chamber, a temperature sensor for detecting fuel vapor temperature in the vaporizing chamber, a temperature regulator for regulating the fuel vapor temperature in the vaporizing chamber, and an electronic control unit (ECU) adapted to operate the fuel pump and the fuel vapor generator and also operate the temperature regulator, to detect temperatures at plural points through the temperature sensor and detect pressures corresponding to the temperatures through the pressure sensor in the process of operation of the temperature regulator, and to calculate fuel vapor pressure characteristics based on the detected temperatures and pressures at the plural points.

### CROSS-REFERENCE TO RELATED APPLICATIONS

This application is based upon and claims the benefit of priority from the prior Japanese Patent Application No. 2008-313114 on Dec. 9, 2008, the entire contents of which are incorporated herein by reference.

### TECHNICAL FIELD

The present invention relates to a fuel vapor pressure measuring apparatus for measuring vapor pressure of fuel to be supplied to an internal combustion engine and the like.

### BACKGROUND ART

Gasoline is currently used as main fuel for internal combustion engines and others. However, the property of commercially available fuel (gasoline) is not always constant. Thus, the vapor pressure of such fuel varies under predetermined conditions. In particular, the fuel property is likely to be different in different destination places and the fuel vapor pressure is also apt to vary. Furthermore, variation in fuel vapor pressure may affect the combustion quality of an internal combustion engine. For avoiding such defects, under present circumstances, internal combustion engines are adapted or adjusted for each destination place.

However, fuel vapor pressure also changes due to fuel oxidation, fuel vaporization, etc. Even if the internal combustion engines are adapted for destination places, therefore, it is difficult to optimally control a fuel injection amount, injection timing, ignition timing, and others in all the internal combustion engines. When the fuel injection amount, injection timing, ignition timing, and others could not be optimally controlled due to variations in fuel vapor pressure, it is feared that startability, emission performance, and drivability of the internal combustion engines are deteriorated particularly in cold period.

In all the internal combustion engines, as above, for optimal control of the fuel injection amount, injection timing, ignition timing, and others, they have to be controlled according to the fuel vapor pressure characteristics (fuel property). Accordingly, the fuel vapor pressure characteristics (fuel property) has to be measured. As a technique of measuring such fuel vapor pressure characteristics (fuel property), heretofore, there are known for example apparatuses disclosed in JP 63 (1988)-111442A, JP 2 (1990)-501328T2, and JP 5 (1993)-223723A. In particular, JP 63 (1988)-111442A discloses a method of measuring vapor pressure of a hydrocarbon liquid mixture and an apparatus employed in the method. This technique is performed by causing a liquid to flow through a nozzle and obtaining data, thereby measuring full pressure at a vapor intake port of the nozzle at a certain fixed temperature as a function of pressure difference of the liquid between both ends of the nozzle. More specifically, the technique is conducted by measuring full pressure at a minimum pressure point of each of the nozzles, measuring a pressure difference between both ends of each nozzle, and thereby changing an amount of flow allowed to pass through each nozzle. In this way, the vapor pressure of a specific liquid compositions and the composition of liquid hydrocarbon are determined.

### SUMMARY OF INVENTION

### Technical Problem

However, the apparatus disclosed in JP 63 (1988)-111442A could change vapor pressure under a certain temperature condition but could not correctly specify different compositions under a temperature condition and vapor pressure at a single point. For instance, the fuel such as gasoline is constituted of plurality of components and thus even different-type fuels exhibit the same vapor pressure at a certain temperature but different vapor pressures at another temperature. It is therefore impossible to correctly ascertain the fuel vapor pressure characteristics related to the fuel type and the fuel composition. JP 63 (1988)-111442A neither discloses nor suggests estimation or presumption of the composition of liquid hydrocarbon, i.e., the fuel type and the fuel composition, from the vapor pressures measured under different temperature conditions.

The present invention has been made in view of the above circumstances and has a purpose to provide a fuel vapor pressure measuring apparatus capable of correctly estimating fuel vapor pressure characteristics related to fuel types and fuel compositions.

### Solution to Problem

To achieve the above purpose, according to one aspect, the invention provides a fuel vapor pressure measuring apparatus comprising: a fuel pump for pressure feeding fuel; a fuel vapor generating section including a nozzle, a venturi, and a vaporizing chamber provided around the nozzle, the fuel vapor generating section being configured to allow the fuel pressure-fed from the fuel pump to be injected from the nozzle and pass through the venturi, thereby vaporizing the fuel in the vaporizing chamber; a pressure detecting section for detecting pressure of fuel vapor in the vaporizing chamber of the fuel vapor generating section; a temperature detecting section for detecting temperature of the fuel vapor in the vaporizing chamber of the fuel vapor generating section; a temperature regulating section for regulating the temperature of the fuel vapor in the vaporizing chamber of the fuel vapor generating section; and a fuel vapor pressure characteristics calculating section adapted to operate the fuel pump and the fuel vapor generating section and also operate the temperature regulating section, to detect temperatures at plural points through the temperature detecting section and detect pressures corresponding to the temperatures at the plural points through the pressure detecting section in the process of operation of the temperature regulating section, and to calculate fuel vapor pressure characteristics based on the detected temperatures and pressures at the plural points.

According to another aspect, the invention provides a fuel vapor pressure measuring apparatus comprising: a fuel pump for pressure feeding fuel; a plurality of fuel vapor generating sections each including a nozzle, a venturi, and a vaporizing chamber provided around the nozzle, each fuel vapor generating section being configured to allow the fuel pressure-fed from the fuel pump to be injected from the nozzle and pass through the venturi, thereby vaporizing the fuel in the vaporizing chamber; pressure detecting sections for detecting pressures of fuel vapor in the vaporizing chambers of the fuel vapor generating sections; temperature detecting sections for detecting temperatures of the fuel vapor in the vaporizing chambers of the fuel vapor generating sections; a temperature regulating section for regulating the temperature of the fuel vapor in the vaporizing chamber of at least one of the fuel vapor generating sections; and a fuel vapor pressure characteristics calculating section adapted to operate the fuel pump and the fuel vapor generating sections and also operate the temperature regulating sections, to detect the temperatures at plural points through the temperature detecting sections and detect the pressures corresponding to the temperatures at the plural points through the pressure detecting sections in the process of operation of the temperature regulating section, and to calculate fuel vapor pressure characteristics based on the detected temperatures and pressures at the plural points.

According to another aspect, the invention provides a fuel vapor pressure measuring apparatus comprising: a fuel pump for pressure feeding fuel; a fuel vapor generating section including a nozzle, a venturi, and a vaporizing chamber provided around the nozzle, the fuel vapor generating section being configured to allow the fuel pressure-fed from the fuel pump to be injected from the nozzle and pass through the venturi, thereby vaporizing the fuel in the vaporizing chamber; a pressure detecting section for detecting pressure of fuel vapor in the vaporizing chamber of the fuel vapor generating section; a temperature detecting section for detecting temperature of the fuel vapor in the vaporizing chamber of the fuel vapor generating section; a fuel pressure changing section for increasing pressure of the fuel to be pressure-fed to the nozzle of the fuel vapor generating section; and a fuel vapor pressure characteristics calculating section adapted to operate the fuel pump and the fuel vapor generating section and also operate the fuel pressure changing section, to detect the temperature several times through the temperature detecting section and detect the pressure several times through the pressure detecting section in the process of operation of the fuel pressure changing section, and to calculate fuel vapor pressure characteristics based on the detected temperatures and pressures at the plural points.

### ADVANTAGEOUS EFFECTS OF INVENTION

According to the above configuration, the fuel vapor pressure characteristics related to the fuel type and the fuel composition can be correctly estimated.

### BRIEF DESCRIPTION OF DRAWINGS

FIG. 1 is a schematic configuration view showing an engine system in a first embodiment;

FIG. 2 is a cross sectional view showing a main configuration of a fuel vapor pressure measuring apparatus in the first embodiment;

FIG. 3 is an enlarged cross sectional view showing a fuel vapor generating section in the first embodiment;

FIG. 4 is a block diagram showing a configuration and others of the fuel vapor pressure measuring apparatus in the first embodiment;

FIG. 5 is a flowchart showing the details of fuel supply control and ignition timing control at engine start-up in the first embodiment;

FIG. 6 is a flowchart showing the details of a fuel vapor pressure measurement process in the first embodiment;

FIG. 7 is a graph showing a relation between nozzle injection flow amount and vaporizing chamber pressure (fuel vapor pressure) in the first embodiment;

FIG. 8 is a graph showing fuel vapor pressure characteristics of a certain fuel by linear approximation using Clausius-Clapeyron Equation in the first embodiment;

FIG. 9 is a graph showing the fuel vapor pressure characteristics linearly approximated in the first embodiment;

FIG. 10 is a graph showing in comparison the linearly approximated for fuel vapor pressure characteristics of fuels of different types in the first embodiment;

FIG. 11 is a graph showing a difference in mixing ratio of ethanol in ethanol blended gasoline in the first embodiment;

FIG. 12 is a graph showing a difference in fuel vapor pressure characteristics between fuels of different types in the first embodiment;

FIG. 13 is a cross sectional view showing a main configuration of a fuel vapor pressure measuring apparatus in a second embodiment;

FIG. 14 is a block diagram showing a configuration and others of the fuel vapor pressure measuring apparatus in the second embodiment;

FIG. 15 is a flowchart showing the details of a fuel vapor pressure measurement process in the second embodiment;

FIG. 16 is a block diagram showing a configuration and others of a fuel vapor pressure measuring apparatus in a third second embodiment;

FIG. 17 is a cross sectional view showing a main configuration of a fuel vapor pressure measuring apparatus in a fourth embodiment;

FIG. 18 is a graph showing a relation between fuel vapor pressure and fuel temperature by referring to a difference in fuel pressure in the fourth embodiment;

FIG. 19 is a flowchart showing the details of fuel supply control and ignition timing control at engine start-up in the fourth embodiment;

FIG. 20 is a flowchart showing the details of the fuel supply control and the ignition timing control during engine operation in the fourth embodiment;

FIG. 21 is a flowchart showing the details of a fuel vapor pressure measurement process in the fourth embodiment;

FIG. 22 is a graph showing a relation between fuel vapor pressure and fuel temperature by referring to a difference in fuel pressure in the fourth embodiment;

FIG. 23 is a cross sectional view showing a main configuration of a fuel vapor pressure measuring apparatus in the fifth embodiment;

FIG. 24 is a flowchart showing the details of fuel supply control and ignition timing control at engine start-up in the fifth embodiment;

FIG. 25 is a time chart showing fuel pressure variation from engine start in the fifth embodiment;

FIG. 26 is a cross sectional view showing a main configuration of a fuel vapor pressure measuring apparatus in another embodiment;

FIG. 27 is a cross sectional view showing a main configuration of a fuel vapor pressure measuring apparatus in another embodiment;

FIG. 28 is a cross sectional view showing a main configuration of a fuel vapor pressure measuring apparatus in another embodiment; and

FIG. 29 is a schematic configuration view showing an engine system in another embodiment.

### DESCRIPTION OF EMBODIMENTS

### First Embodiment

A detailed description of a first preferred embodiment of a fuel vapor pressure measuring apparatus of the present invention applied to a vehicle engine system will now be given referring to the accompanying drawings.

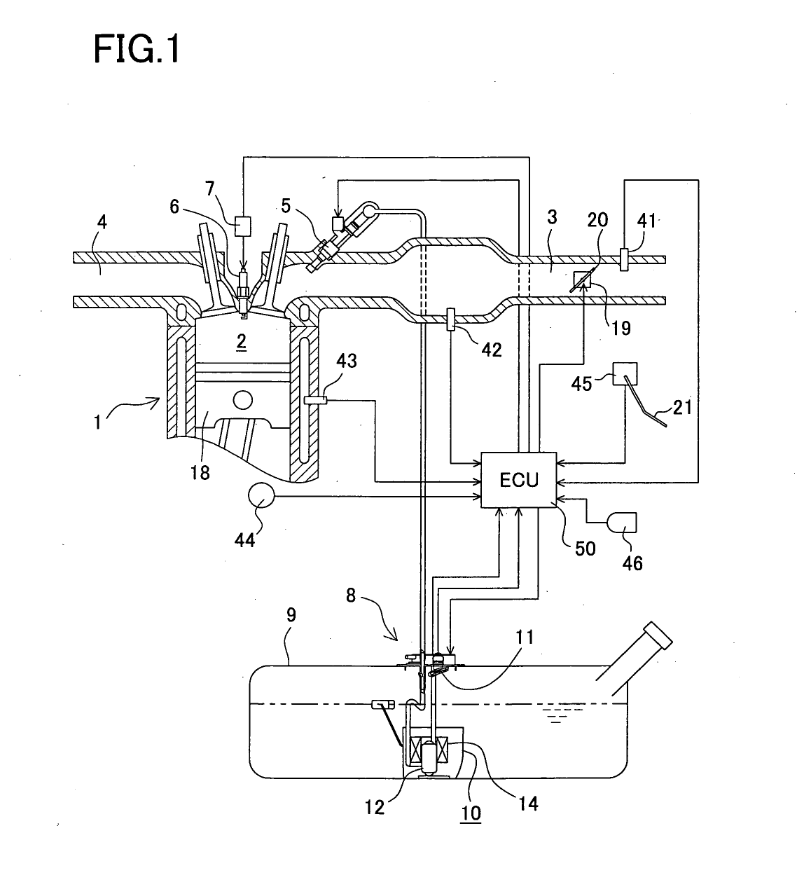

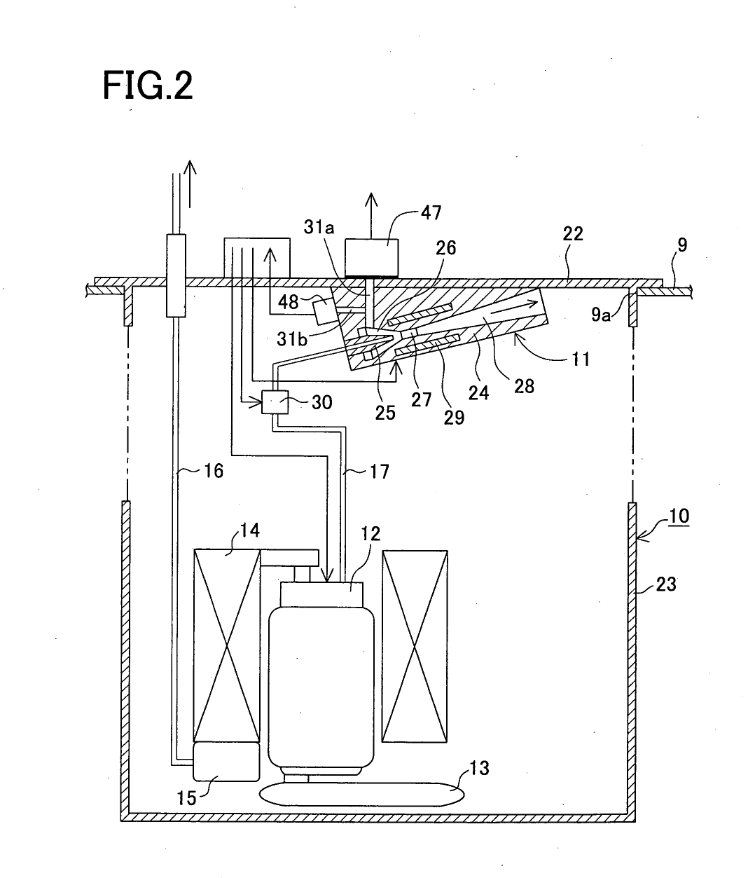

FIG. 1 is a schematic configuration view of an engine system mounted in a vehicle. FIG. 2 is a cross sectional view of a main configuration of the fuel vapor pressure measuring apparatus. As shown in FIG. 1, an engine 1 constituting the engine system includes an intake passage 3 for introducing outside air into a combustion chamber 2 and an exhaust passage 4 for discharging exhaust gas out of the combustion chamber 2. In the intake passage 3, an injector 5 is provided in correspondence with each combustion chamber 2. The injector 5 is configured to open a valve by energization to thereby inject fuel into the intake passage 3. In the engine 1, an ignition plug 6 is provided in correspondence with each combustion chamber 2. The ignition plug 6 is operated to ignite the fuel upon receipt of high voltage output from an igniter 7. Ignition timing of the ignition plug 6 is determined by output timing of the high voltage from the igniter 7.

The engine system includes a fuel supply device 8 for supplying fuel into the combustion chamber 2. This fuel supply device 8 includes, in addition to the injector 5, a fuel tank 9 for storing the fuel to be supplied to the injector 5 and a fuel pump unit 10 housed in the fuel tank 9. A fuel vapor generator 11 is placed inside the tank 9. As shown in FIG. 2, the fuel pump unit 10 includes a fuel pump 12, a low-pressure filter 13, a high-pressure filter 14, a pressure regulator 15, a first fuel passage 16, and a second fuel passage 17. The fuel pump 12 is used to pressure feed fuel into the injector 5 and the fuel vapor generator 11 respectively. When the pump 12 is activated, fuel in the tank 9 is sucked by the pump 12 through the low-pressure filter 13 and discharged from the pump 12. The discharged fuel is pressure fed to the injector 5 via the high-pressure filter 14, the pressure regulator 15, the first fuel passage 16, and others. The fuel discharged from the fuel pump 12 can also be pressure fed to the fuel vapor generator 11 through the second fuel passage 17. The fuel discharged from the pump 12 is regulated to a predetermined pressure by the pressure regulator 15 and then supplied to the first and second fuel passages 16 and 17 respectively. The fuel pressure-fed to the injector 5 is injected into the intake passage 3 by operation of the injector 5. The injected fuel is mixed with intake air to form an air-fuel mixture and fed into the combustion chamber 2. This air-fuel mixture is exploded and burnt by operation of the ignition plug 6 in the combustion chamber 2. Exhaust gas resulting from the burning is discharged to the outside through the exhaust passage 4. In the above sequence of steps, a piston 18 is moved up and down to rotate a crank shaft (not shown), thereby providing power to the engine 1.

As shown in FIG. 1, the intake passage 3 is internally provided with an electronic throttle device 19 for regulating an amount of intake air. This device 19 is driven by a motor to open and close a throttle valve 20. In the intake passage 3, an intake air temperature sensor 41 for detecting intake air temperature THA is mounted upstream of the electronic throttle device 19 and also an intake air pressure sensor 42 for detecting intake air pressure PM is mounted downstream of the electronic throttle device 19. The engine 1 are provided with a water temperature sensor 43 for detecting cooling water temperature THW and a rotational speed sensor 44 for detecting rotational speed of the crank shaft (i.e., engine rotational speed) NE. An accelerator pedal 21 is located on the driver's seat side and to be operated by a driver. This pedal 21 is attached with an accelerator sensor 45 for detecting an operation amount (accelerator opening degree) ACCP of the pedal 21. On the driver's seat side, furthermore, an ignition switch (IG switch) 46 is provided to start the engine 1. An operating state of the engine 1 is detected by the above intake air temperature sensor 41, intake air pressure sensor 42, water temperature sensor 43, rotational speed sensor 44, accelerator sensor 45, and IG switch 46.

As shown in FIG. 1, the engine system further includes an electronic control unit (ECU) 50 for controlling operations of the engine 1. The ECU 50 is electrically connected to the aforementioned injector 5, igniter 7, fuel pump 12, electronic throttle device 19, intake air temperature sensor 41, intake air pressure sensor 42, water temperature sensor 43, rotational speed sensor 44, accelerator sensor 45, and IG switch 46, respectively. The ECU 50 is configured to control the injector 5, the igniter 7, the fuel pump 12, and the electronic throttle device 19 separately in order to execute fuel supply control, ignition timing control, and other controls according to the operating state of the engine 1 based on detection signals from the various sensors 41 to 46.

Herein, the fuel supply control represents controlling a discharge amount by the fuel pump 12 (the number of revolutions of a pump motor), a fuel injection amount from the injector 5 (a valve opening duration) and its injection timing according to the operating state of the engine 1. The ignition timing control represents controlling an ignition timing of the ignition plug 6 by controlling the igniter 7 according to the operating state of the engine 1.

The ECU 50 includes known components such as a central processing unit (CPU), a read only memory (ROM), a random access memory (RAM), a backup RAM, an external input circuit, and an external output circuit. The ROM stores in advance predetermined control programs related to various controls mentioned above. The RAM temporarily stores calculation results and others of the CPU. The backup RAM saves the previously stored data. The CPU executes the above controls and others in accordance with the predetermined control programs based on the detection signals input from the various sensors 41 to 46 through the input circuit.

As shown in FIG. 1, the fuel tank 9 stores fuel. In this tank 9, the fuel pump unit 10 and the fuel vapor generator 11 are placed. As shown in FIG. 2, the fuel pump unit 10 further includes a set plate 22 fitted in a mounting hole 9a of the tank 9 and a reserve cup 23 coupled to the set plate 22. In the reserve cup 23, the fuel pump 12, the low-pressure filter 13, the high-pressure filter 14, and the pressure regulator 15 are housed. The fuel vapor generator 11 is attached to an inner surface of the set plate 22 within the reserve cup 23.

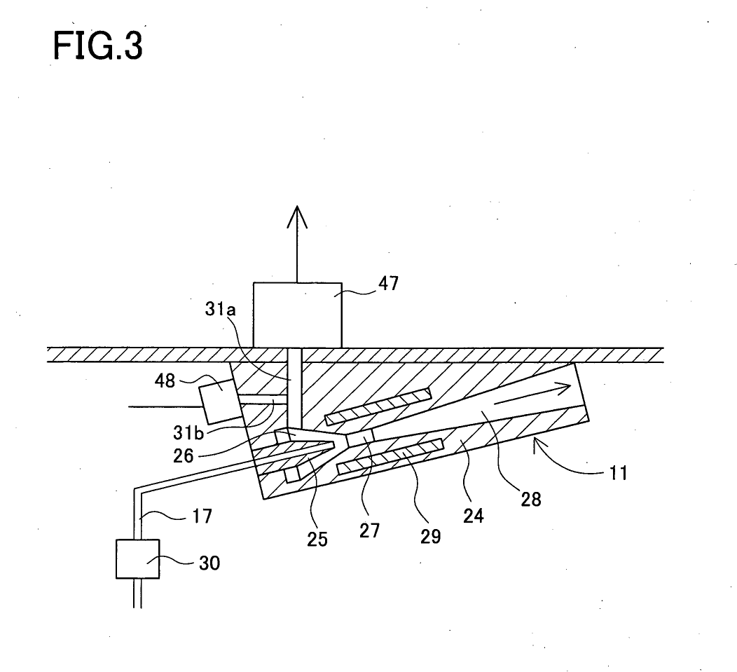

FIG. 3 is an enlarged cross sectional view of the fuel vapor generator 11. The fuel vapor generator 11 is to vaporize fuel under reduced pressure in order to measure vapor pressure of the fuel stored in the fuel tank 9. The fuel vapor pressure is detected as a pressure obtained when fuel is vaporized under reduced pressure. As shown in FIGS. 2 and 3, the fuel vapor generator 11 includes a body 24 attached to the set plate 22, a nozzle 25 provided in the body 24, a vaporizing chamber 26 formed in the body 24 so as to surround the nozzle 25, a throat 27 and a diffuser 28 constituting a venturi communicating with the vaporizing chamber 26 in the body 24, and a temperature regulator 29 located in the body 24 around the vaporizing chamber 26 and the throat 27 and the diffuser 28. In the fuel vapor generator 11, when the fuel pressure-fed from the fuel pump 12 is injected, the injected fuel sticks to the throat 27 and then flows at high velocity, thereby sucking the vaporizing chamber 26 to form negative pressure therein. That is, the fuel in the vaporizing chamber 26 is vaporized under reduced pressure. To be concrete, the fuel injected from the nozzle 25 is supplied into the vaporizing chamber 26 while increasing the flow velocity, and passes the throat 27 and the diffuser 28 and then returns to the reserve cup 23. When the fuel injected from the nozzle 25 passes the throat 27, the fuel in the vaporizing chamber 26 is drawn toward the diffuser 28 due to the influence of fuel viscosity, thereby generating negative pressure in the vaporizing chamber 26. By the action of this negative pressure, the fuel in the vaporizing chamber 26 is vaporized under reduced pressure, so that fuel vapor occurs in the vaporizing chamber 26. The pressure in the vaporizing chamber 26 achieves an equilibrium state by fuel vapors. A method of measuring fuel vapor pressure by use of the fuel vapor generator 11 is referred to as a “dynamic vapor pressure method” in contrast to a “static vapor pressure method” of simply measuring fuel vapor pressure in a closed vessel.

As shown in FIGS. 2 and 3, the second fuel passage 17 extending from the fuel pump 12 is connected to the nozzle 25. An open/close valve 30 constituted of an electromagnetic valve is placed somewhere in this passage 17 in order to selectively interrupt the flow of fuel. This open/close valve 30 is opened only during measurement of the fuel vapor pressure and others to cause the fuel to be injected from the nozzle 25, thereby reliably generating the negative pressure in the vaporizing chamber 26. As shown in FIGS. 1 and 2, the open/close valve 30 is electrically connected to and controlled by the ECU 50.

As shown in FIGS. 2 and 3, the temperature regulator 29 is integrally provided in the body 24. This temperature regulator 29 is placed to surround the vaporizing chamber 26 and the throat 27 and the diffuser 28 in order to adjust the temperature of fuel vapors generated in the vaporizing chamber 26. As the temperature regulator 29, a PTC heater for high temperature, a Peltier element for low temperature, a vortex tube, or the like may be used. As shown in FIGS. 1 and 2, the temperature regulator 29 is electrically connected to and controlled by the ECU 50.

As shown in FIGS. 2 and 3, the body 24 and the set plate 22 are formed with a pressure hole 31a communicating with the vaporizing chamber 26. The body 24 is further formed with a temperature hole 31b communicating with the pressure hole 31a. A pressure sensor 47 is mounted on the set plate 22 in correspondence with the pressure hole 31a. The pressure sensor 47 detects the pressure of fuel vapor generated in the vaporizing chamber 26 through the pressure hole 31a. As shown in FIGS. 1 and 2, the pressure sensor 47 is electrically connected to the ECU 50 so that a detection signal from the sensor 47 is input to the ECU 50.

As shown in FIGS. 2 and 3, a temperature sensor 48 is mounted on the body 24 in correspondence with the temperature hole 31b. Through this temperature hole 31b, the temperature sensor 48 detects, as a fuel vapor temperature, the temperature of fuel during vaporization in the vaporizing chamber 26. As shown in FIGS. 1 and 2, the temperature sensor 48 is electrically connected to the ECU 50 so that a detection signal output from the sensor 48 is input to the ECU 50.

In this embodiment, the diameter of the nozzle 25 is set to “0.9 mm”, the diameter of the throat 27 is set to “1.5 mm”, and the distance between the nozzle 25 and the throat 27 is set to “3 mm”. These values are determined according to the performance of the fuel pump 12 and not limited to the above.

Since the fuel vapor generator 11 is provided in the fuel tank 9 as mentioned above, even the fuel flowing out of the fuel vapor generator 11 causes no problem. Thus, the configuration of the fuel vapor generator 11, particularly, the sealing configuration can be simplified. Furthermore, the fuel vapor generator 11 can be modularized together with the fuel pump unit 10 and hence such modularized assembly is easy to mount, with the result of a simplified mounting member.

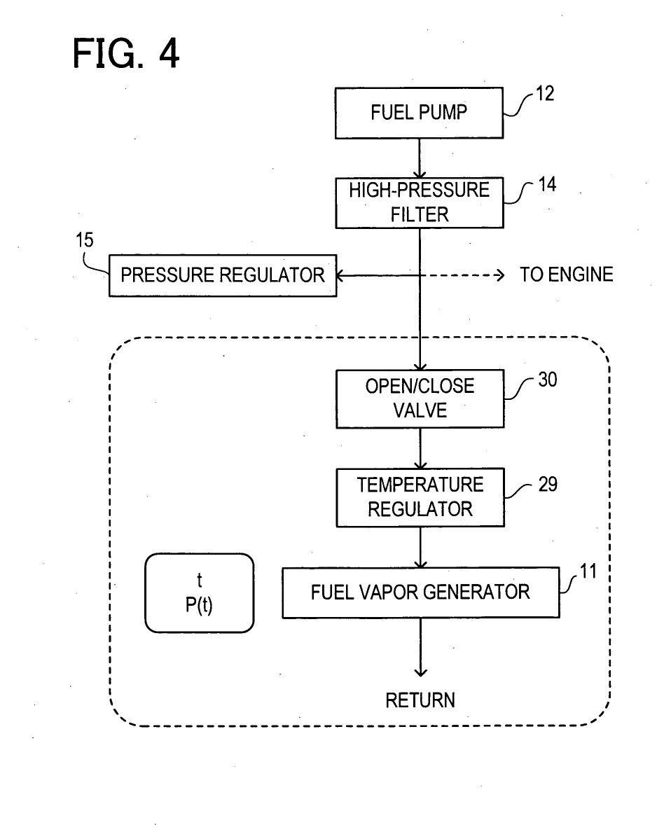

FIG. 4 is a block diagram showing a configuration and others of the fuel vapor pressure measuring apparatus in this embodiment. The fuel discharged from the fuel pump 12 is filtered by the high-pressure filter 14 and then regulated to a predetermined pressure by the pressure regulator 15. This pressure-regulated fuel is supplied to the engine 1 and also supplied to the fuel vapor generator 11 and others. The second fuel passage 17 is provided with the open/close valve 30. While this valve 30 is closed, the pressure-regulated fuel is not supplied to the fuel vapor generator 11 and others. When the valve 30 is opened, the pressure-regulated fuel is supplied to the fuel vapor generator 11 and others while the temperature of the fuel is controlled by the temperature regulator 29. The fuel is then vaporized under reduced pressure. At that time, the temperature t of the fuel vapor in the vaporizing chamber 26 and the pressure P(t) of the fuel vapor corresponding to the temperature t are detected. The ECU 50 calculates the fuel vapor pressure characteristics based on those temperature t and the pressure P(t). Furthermore, residual fuel in the fuel vapor generator 11 is returned to the reserve tank 23 (the fuel tank 9).

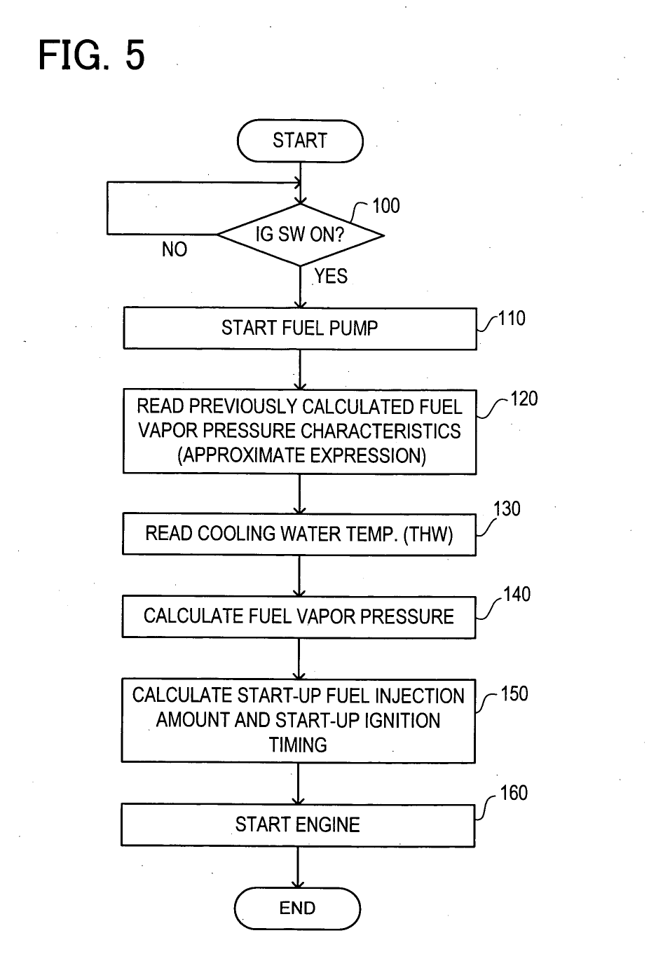

Herein, the details of the fuel supply control and the ignition timing control at engine start-up are explained. FIG. 5 is a flowchart showing the control details.

When the IG switch 46 is turned on in step 100, firstly, the ECU 50 starts the fuel pump 12 in step 110.

In step 120, the ECU 50 reads fuel vapor pressure characteristics (an approximate expression) calculated at a previous time. This fuel vapor pressure characteristics has been calculated in a previous measurement and written in the RAM of the ECU 50.

In step 130, the ECU 50 reads the cooling water temperature THW based on a detection signal from the water temperature sensor 43. Based on this cooling water temperature THW, a current fuel temperature can be estimated.

In step 140, the ECU 50 refers to the fuel vapor pressure read in step 120 and calculates current fuel vapor pressure based on the cooling water temperature THW read in step 130. Herein, calculating the fuel vapor pressure based on the cooling water temperature THW is conducted to correctly calculate the vapor pressure of fuel to be injected from the injector 5 at the current fuel temperature. In a cold region, for example, outside air temperature may be low even after warm-up of the engine 1 is completed. In this case, if the fuel vapor pressure is simply calculated based on the outside air temperature, the vapor pressure of fuel to be injected from the injector 5 cannot be calculated correctly. In this embodiment, therefore, the cooling water temperature THW whereby the fuel temperature can be estimated is used for calculation of the fuel vapor pressure.

In step 150, the ECU 50 calculates a fuel injection amount and an ignition timing for start-up respectively based on the calculated fuel vapor pressure. The ECU 50 makes this calculation by referring to a start-up fuel injection amount map and a start-up ignition timing map, both being previously determined. The ECU 50 thus makes a correction to increase the start-up fuel amount and simultaneously a correction of the start-up ignition timing.

In step 160, the ECU 50 controls the injector 5 and the igniter 7 based on the fuel injection amount and the ignition timing calculated in step 150 to start the engine 1.

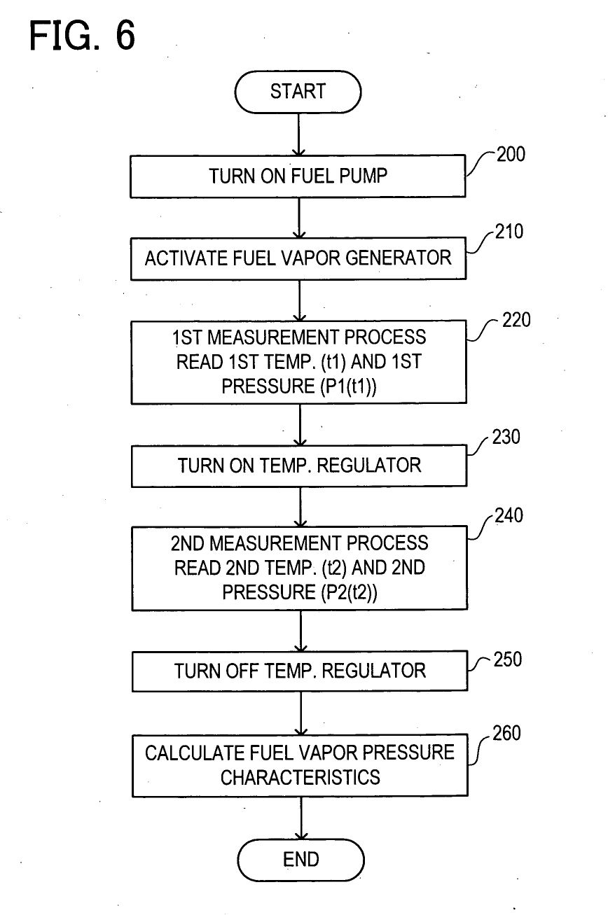

Next, the details of a fuel vapor pressure measurement process in this embodiment are explained. FIG. 6 is a flowchart showing the details of the process. The ECU 50 executes this routine after the end of operation of the engine 1.

In step 200, firstly, the ECU 50 turns on the fuel pump 12. At that time, the operation of the engine 1 has been terminated and accordingly the fuel pump 12 once stopped is activated again for the fuel vapor pressure measurement process.

In step 210, the ECU 50 activates the fuel vapor generator 11. To be concrete, the ECU 50 opens the open/close valve 30 to inject fuel from the nozzle 25. Thus, the fuel injected from the nozzle 25 sticks to the throat 27 and flows at high velocity, thereby sucking the vaporizing chamber 26 to generate negative pressure. The fuel in the vaporizing chamber 26 is vaporized under reduced pressure.

In step 220, the ECU 50 executes a first measurement process. To be concrete, after a lapse of a predetermined time from the start of the process in step 210, the ECU 50 reads a first temperature t1 of the fuel vapor detected by the temperature sensor 48 and a first pressure P1(t1) that is the fuel vapor pressure detected by the pressure sensor 47 at the same time the first temperature t1 is detected.

In step 230, subsequently, the ECU 50 turns on the temperature regulator 29 to thereby change the temperatures of the vaporizing chamber 26, the throat 27, and the diffuser 28. For instance, the temperatures of those areas 26 to 28 are raised, thereby increasing the temperature of the fuel vapor generated in the vaporizing chamber 26.

In step 240, the ECU 50 executes a second measurement process. To be concrete, after a lapse of a predetermined time from the start of the process in step 230, the ECU 50 then reads respectively a second temperature t2 of the fuel vapor detected by the temperature sensor 48 and a second pressure P2(t2) that is the fuel vapor detected by the pressure sensor 47 at the same time the second temperature t2 is detected.

The ECU 50 then turns off the temperature regulator 29 in step 250 and calculates the fuel vapor pressure characteristics (an approximate expression) based on each of the temperatures t1 and t2 and each of the pressures P1(t1) and P2(t2) read in steps 220 and 240, and stores a calculation result in the RAM of the ECU 50.

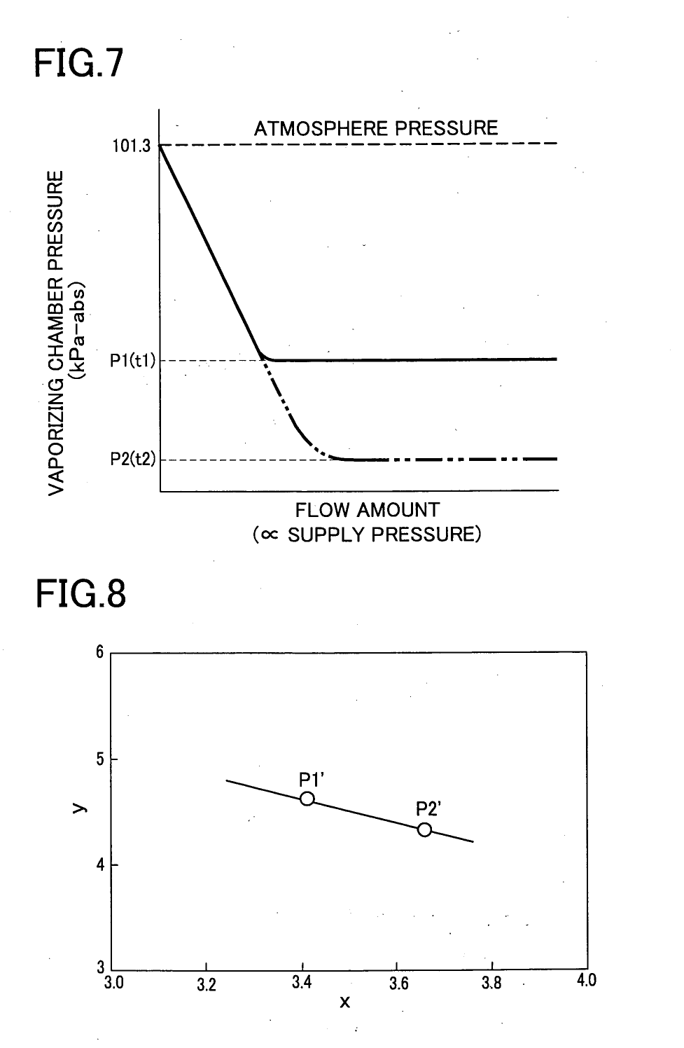

Herein, an explanation is given to the calculation of the fuel vapor pressure characteristics executed in step 260. FIG. 7 is a graph showing a relation between a flow amount of the fuel injected from the nozzle 25 of the fuel vapor generator 11 and a vaporizing chamber pressure (fuel vapor pressure) detected by the pressure sensor 47. The vaporizing chamber pressure (the first and second pressures P1(t1) and P2(t2)) detected by the pressure sensor 47 decreases as the injection flow amount from the nozzle 25 increases, and then the pressure becomes a fixed value as shown in FIG. 7. The vaporizing chamber pressure (the first and second pressures P1(t1) and P2(t2)) becoming this fixed value is different according to the temperatures t1 and t2 of the fuel vapor in the vaporizing chamber 26. Then, the pressures P1(t1) and P2(t2) at two points (or two time points) differing according the temperatures t1 and t2 at two points are expressed in logarithm and linearly approximated.

Specifically, assuming that the fuel vapor pressure is P (kPa) for the fuel vapor temperature of t (° C.), the following expressions are given by Clausius-Clapeyron Equation.

x=1/T*1000

y=log 10(P*1000)

Herein, by using the reciprocal of an absolute temperature T (=t+273.15) and expressing the fuel vapor pressure in logarithm, the fuel vapor pressure characteristics is linearly approximated and expressed by the following equation:

y=A*x+B

where “A” denotes a coefficient and “B” denotes a constant, each being different according to fuel types and fuel properties. FIG. 8 is a graph showing the fuel vapor pressure characteristics of a certain fuel linearly approximated by Clausius-Clapeyron Equation. In this graph, the lateral axis indicates the logarithm of temperature and the vertical axis indicates the reciprocal of pressure. In FIG. 8, the graph is plotted with two points for simplification but may be plotted with three or more measured points. The temperatures at two points need to be different by 5° C. or more and more preferably 10° C. or more.

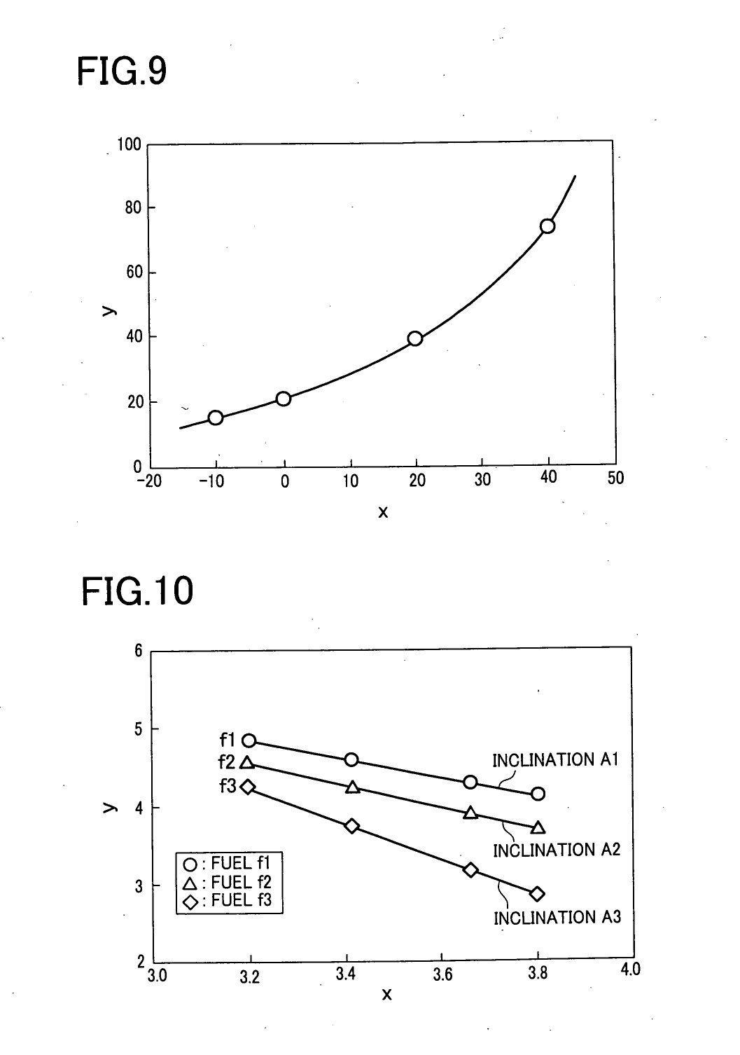

On the other hand, when the pressure is measured at three or more different points based on the temperatures at three or more points, the fuel vapor pressure characteristics can be exponentially approximated directly as a curved line. Herein, assuming that the fuel vapor temperature (the temperature of the vaporizing chamber) is t (=x) and the fuel vapor fuel vapor pressure is P (=y), the following exponential approximate expression is obtained. Furthermore, the fuel vapor pressure characteristics can be expressed in a curve-approximated graph as shown in FIG. 9.

y=C*EXP(D*x)

By such exponentially expressing, a curved line can be determined at two points according to some materials.

In this embodiment, the fuel vapor pressure characteristics expressed in the above straight or curved line is calculated from two pressures P1(t1) and P2(t2) corresponding to the temperatures t1 ant t2 at two points.

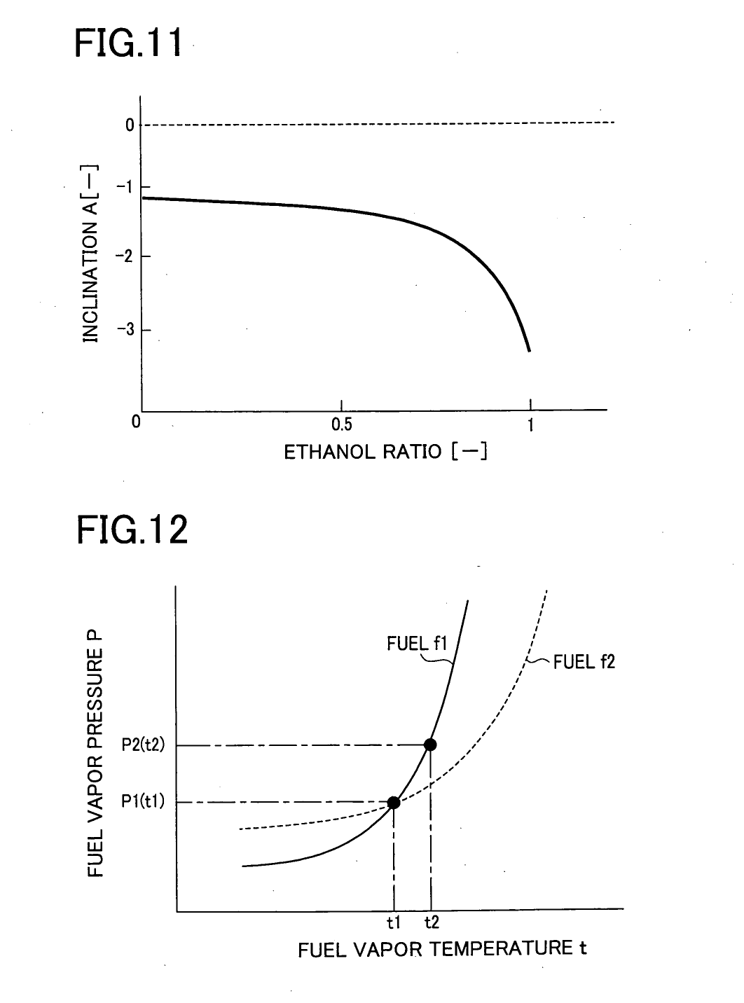

Accordingly, the values of “A” and “B” of fuels of different types are calculated respectively by the linear approximate expression (y=A*x+B) logarithmically represented as shown in FIG. 8. Thus, the fuel vapor pressures can be compared at arbitrary temperatures. FIG. 10 is a graph showing in comparison the linearly approximated fuel vapor pressure characteristics of fuels f1 to f3 of different types. This graph reveals that inclinations A1 to A3 of the linearly approximated fuel vapor pressure characteristics are different between the fuels f1 to f3 of different types. From this difference between the inclinations A1 to A3, a mixture ratio of fuel components can be determined. For example, FIG. 11 is a graph showing a difference in ethanol mixing ratio of ethanol blended gasoline. In FIG. 11, the lateral axis indicates an ethanol ratio and the vertical axis indicates a difference in inclinations A1 to A3.

FIG. 12 is a graph showing a relation between the fuel vapor temperature t and the fuel vapor pressure P, i.e., fuel vapor pressure characteristics, of the fuels f1 and f2 of different types. As shown in FIG. 12, the fuel vapor pressure characteristics of the two fuels f1 and f2 are different but exhibit the same temperature P1(t1) at the temperature t1. Accordingly, if the fuel vapor pressure P is merely measured at that temperature t1, it is impossible to determine which is measured, i.e., the fuel vapor pressure characteristics of the fuel f1 or the fuel vapor pressure characteristics of the fuel f2. In this embodiment, however, the two fuel vapor pressures P1(t1) and P2(t2) are measured in correspondence with the temperatures t1 and t2 at two points. Based on these two measurement data, the measurement data can be distinguished as relating to the fuel vapor pressure characteristics of the fuel f1 for example as shown in FIG. 12.

According to the fuel vapor pressure measuring apparatus in this embodiment explained above, the fuel pump 12 and the fuel vapor generator 11 are activated to pressure feed the fuel into the nozzle 25 of the generator 11, thereby causing the fuel to be injected from the nozzle 25. This injected fuel passes through the diffuser 28 and hence vaporizes in the vaporizing chamber 26. At that time, when the temperature regulator 29 is activated, the temperatures t1 and t2 at two points are set during activation of the temperature regulator 29 and these temperatures t1 and t2 at two points are detected by the temperature sensor 48. Furthermore, two pressures P1(t1) and P2(t2) corresponding to the two temperatures t1 and t2 respectively are detected by the pressure sensor 47.

Based on the detected temperatures t1 and t2 and pressures P1(t1) and P2(t2) at two points, the ECU 50 calculates the fuel vapor pressure characteristics. Accordingly, for the fuel vapor generated in the vaporizing chamber 26 of the fuel vapor generator 11, for example, as shown in FIG. 12, different fuel vapor pressure characteristics are specified according to the types of the fuels f1 and f2 from the pressures P1(t1) and P2(t2) at two different points corresponding to the temperatures t1 and t2 at two different points. Thus, the fuel vapor pressure characteristics according to the types of the fuels f1 and f2 can be correctly estimated. The same applies to the case where fuel compositions are different.

In this embodiment, the estimated fuel vapor pressure characteristics is linearly approximated or curve-approximated as shown in FIGS. 8 to 10, so that the gravity of gasoline as fuel can be determined. Furthermore, using the graph in FIG. 11, the concentration of ethanol in ethanol blended gasoline can be estimated.

In this embodiment, by use of the single fuel vapor generator 11 and the single temperature sensor 48 and the single pressure sensor 47, the temperatures t1 and t2 and the pressures P1(t1) and P2(t2) of the fuel vapor at two points can be obtained. Therefore, the fuel vapor generator 11 can be combined with the fuel pump unit 10 into a small module, facilitating mounting of such module in the fuel tank 9.

In this embodiment, moreover, the dynamic vapor pressure method is adopted to estimate the fuel vapor pressure characteristics. Accordingly, as compared with the case of adopting the static vapor pressure method, it is possible to more stably measure the fuel vapor pressure in short time. In this regard, the fuel vapor pressure characteristics can also be estimated more correctly. Since the temperature of fuel vapor is changed by use of the temperature regulator 29, the fuel vapor pressure can be measured in short time in relation to the temperatures at two different points. The temperature of fuel vapor can be changed to intentionally produce a large temperature difference by the temperature regulator 29. Accordingly, the accuracy of measurement of fuel vapor pressure and the accuracy of linear or curve approximation of fuel vapor pressure can be enhanced by just that much. In the fuel vapor generator 11, furthermore, the fuel is injected from the nozzle 25 and allowed to flow to diffuse, thus preventing temperature irregularity in the vaporizing chamber 26.

According to the engine control in this embodiment, the current fuel vapor pressure is determined from the previously determined fuel vapor pressure, and the engine 1 is started based on the fuel injection amount and the ignition timing both corrected based on the determined current fuel vapor pressure. Consequently, the engine 1 can be started more appropriately by reflecting the difference between the fuel vapor pressures.

### Second Embodiment

A second embodiment of a fuel vapor pressure measuring apparatus of the invention applied to a vehicle engine system will be described in detail with reference to the drawings.

In the following explanation, similar or identical components to those in the first embodiment are given the same reference signs and their details are not repeated herein. The following explanation is therefore focused on differences from the first embodiment.

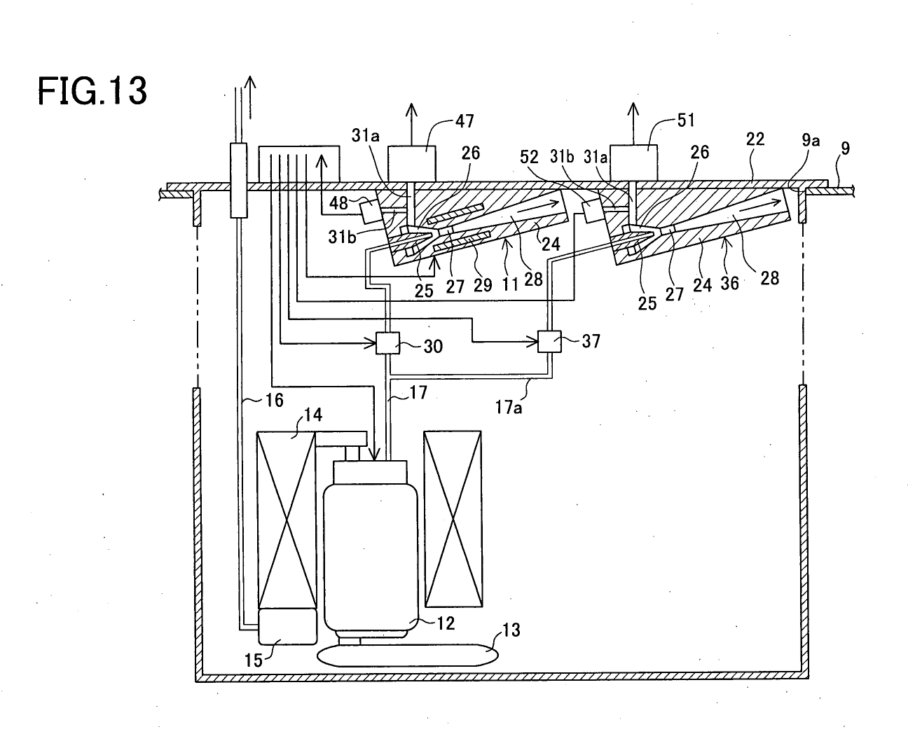

FIG. 13 is a cross sectional view of a main configuration of the fuel vapor pressure measuring apparatus in this embodiment. Differing from the first embodiment including the single-circuit fuel vapor generator, the second embodiment includes double-circuit fuel vapor generators. In this embodiment, specifically, in addition to a first fuel vapor generator 11 and its related components, a second fuel vapor generator 36 and its related components are provided. This second generator 36 is identical in configuration to the first generator 11 excepting that the second generator 36 has no temperature regulator 29. A branch passage 17a branching off from a certain place of a second passage 17 is connected to a nozzle 25 in the second fuel vapor generator 36. In this branch passage 17a, a second open/close valve 37 to be controlled by the ECU 50 is placed. The second fuel vapor generator 36 is provided with a pressure sensor 51 and a temperature sensor 52 respectively as with the first fuel vapor generator 11. Detection signals from those sensors 51 and 52 are input to the ECU 50.

This embodiment includes the fuel vapor generators 11 and 36 in a double circuit in order to simultaneously activate the first generator 11 including the temperature regulator 29 and the second generator 36 including no temperature regulator 29 to thereby simultaneously measure fuel vapor pressures at two points corresponding to the temperatures at two different points.

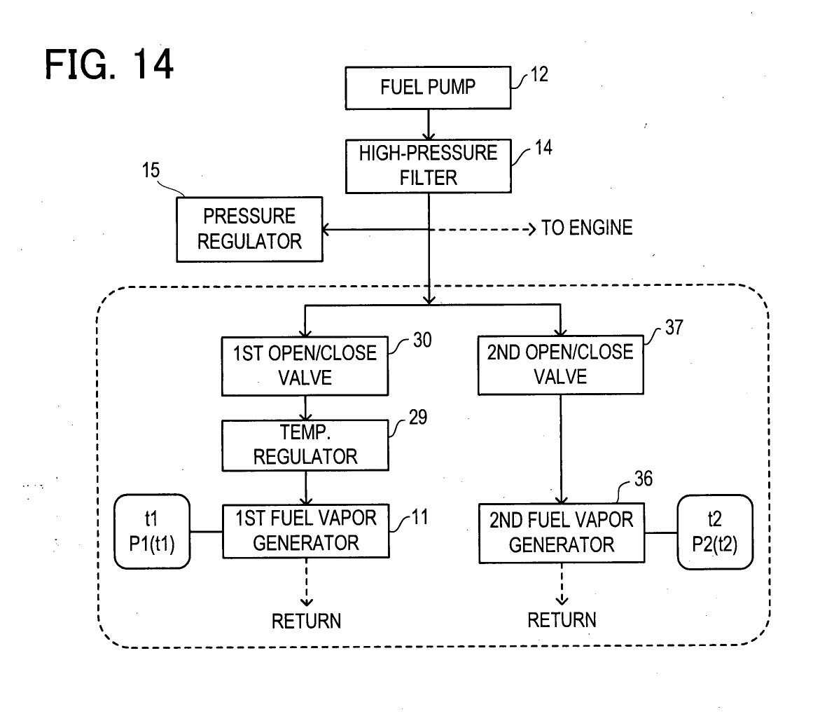

FIG. 14 is a block diagram showing a configuration and others of the fuel vapor pressure measuring apparatus in this embodiment. The fuel discharged from a fuel pump 12 is filtered by a high-pressure filter 14 and regulated to a predetermined pressure by a pressure regulator 15. This pressure-regulated fuel is supplied to an engine 1 and also supplied to the double-circuit fuel vapor generators 11 and 36 and others. The first open/close valve 30 and the second open/close valve 37 are placed in the second fuel passage 17 and the branch passage 17a respectively. Thus, while those valves 30 and 37 are closed, the pressure-regulated fuel is not supplied to the fuel vapor generators 11 and 36 and others. When the valves 30 and 37 are opened, on the other hand, in the first fuel vapor generator 11, the pressure-regulated fuel is vaporized under reduced pressure in the vaporizing chamber 26 while the fuel is regulated in temperature by the temperature regulator 29. In the second fuel vapor generator 36, the pressure-regulated fuel is vaporized under reduced pressure in the vaporizing chamber 26 while the fuel is not regulated in temperature. At that time, in the first fuel vapor generator 11, the temperature t1 of the fuel vapor in the vaporizing chamber 26 and the pressure P1(t1) of the fuel vapor at the temperature t1 are detected. Simultaneously, in the second fuel vapor generator 36, the temperature t2 of the fuel vapor in the vaporizing chamber 26 and the pressure P2(t2) of the fuel vapor for the temperature t2 are detected. The ECU 50 calculates the fuel vapor pressure characteristics based on the temperatures t1 and t2 and the fuel vapor pressures P1(t1) and P2(t2) at two points. The residual fuel in each of the fuel vapor generators 11 and 36 is returned to the fuel tank 9.

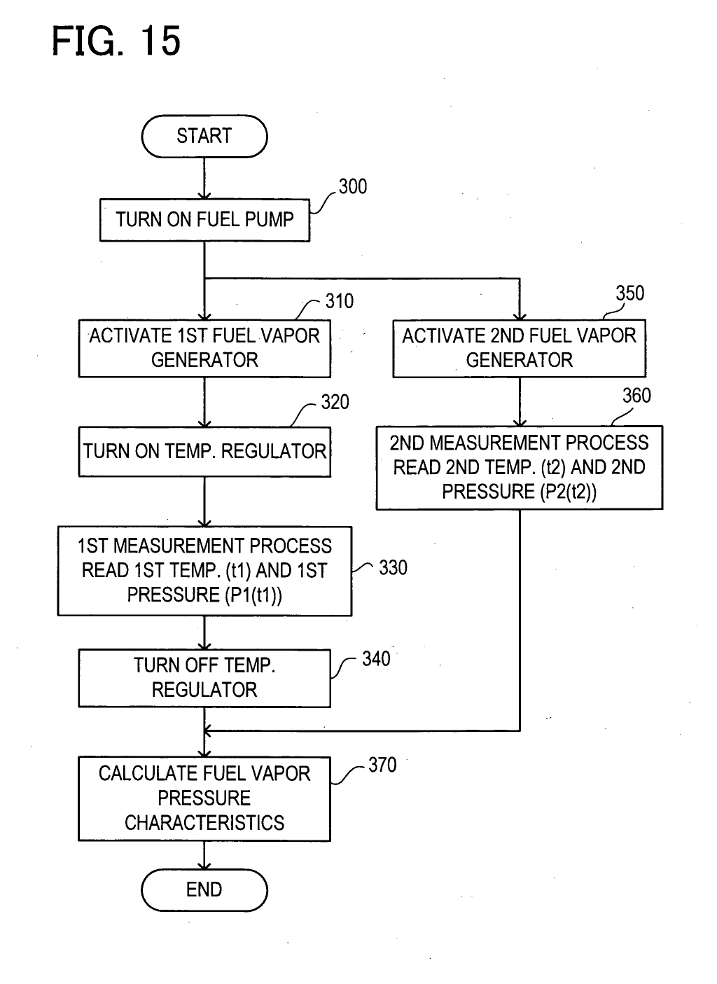

Herein, the details of a fuel vapor pressure measurement process in this embodiment is explained. FIG. 15 is a flowchart showing the details of the process. The ECU 50 executes this routine after the end of operation of the engine 1.

In step 300, firstly, the ECU 50 turns on the fuel pump 12. At that time, the fuel pump 12 having been stopped once after the end of operation of the engine 1 is activated again for the fuel vapor pressure measurement process.

In step 310, the ECU 50 activates the first fuel vapor generator 11. To be concrete, the ECU 50 opens the first open/close valve 30 to inject fuel from the nozzle 25 of the first fuel vapor generator 11. Thus, the injected fuel sticks to a throat 27 and flows at high velocity, thereby sucking the vaporizing chamber 26 to form negative pressure therein. The fuel in the vaporizing chamber 26 is vaporized under reduced pressure.

In step 320, the ECU 50 turns on the temperature regulator 29 to change the temperatures of the vaporizing chamber 26, the throat 27, and the diffuser 28. For instance, the temperatures of those areas 26 to 28 are raised, thereby changing the temperature of the fuel vapor generated in the vaporizing chamber 26.

In step 330, the ECU 50 executes a measurement process. Specifically, after a lapse of a predetermined time from the start of the process in step 320, the ECU 50 reads, respectively, the first temperature t1 of the fuel vapor detected by the temperature sensor 48 and the first pressure P1(t1) of the fuel vapor pressure detected by the pressure sensor 47 at the same time when the first temperature t1 is detected. In step 340, subsequently, the ECU 50 turns off the temperature regulator 29.

In parallel with the processes in steps 310 to 340, the ECU 50 executes the processes in steps 350 and 360. Specifically, in step 350, the ECU 50 activates the second fuel vapor generator 36. To be concrete, the ECU 50 opens the second open/close valve 37 to inject fuel from the nozzle 25 of the second fuel vapor generator 36. Thus, the injected fuel sticks to a throat 27 and flows at high velocity, thereby sucking the vaporizing chamber 26 to generate negative pressure. The fuel in the vaporizing chamber 26 is vaporized under reduced pressure.

In step 360, the ECU 50 then executes a measurement process. Specifically, after a lapse of a predetermined time from the start of the process in step 350, the ECU 50 reads, respectively, the second temperature t2 of the fuel vapor detected by the temperature sensor 52 and the second pressure P2(t2) of the fuel vapor pressure detected by the pressure sensor 51 at the same time when the second temperature t2 is detected.

In step 370, the ECU 50 calculates the fuel vapor pressure characteristics (an approximate expression) based on the temperatures t1 and t2 and the pressures P1(t1) and P2(t2) at two points read in steps 330 and 360, and stores a calculation result in the RAM of the ECU 50. Herein, a calculation method of the fuel vapor pressure characteristics is the same as in the first embodiment.

According to the vapor fuel pressure measuring apparatus in this embodiment explained above, the fuel pump 12 and the two fuel vapor generators 11 and 36 are operated to pressure feed fuel into respective nozzles 25, thereby injecting the fuel from the nozzles 25. When the injected fuel passes through the diffusers 28 and thus vaporized in respective vaporizing chambers 26. At that time, when the temperature regulator 29 is activated, a predetermined temperature is set in the first fuel vapor generator 11 provided with the temperature regulator 29, and a temperature different from the predetermined temperature is set in the second fuel vapor generator 36 provided with no temperature regulator 29. In the two generator generators 11 and 36, the temperatures t1 and t2 at two points are detected by the two temperature sensors 48 and 52. Furthermore, the pressures P1(t1) and P2(t2) at two points corresponding to the temperatures t1 and t2 at two points are detected by the two pressure sensors 47 and 51. Based on the two temperatures t1 and t2 and the two pressures P1(t1) and P2(t2), the ECU 50 calculates the fuel vapor pressure characteristics. Accordingly, for the fuel vapor generated in the vaporizing chambers 26 of the fuel vapor generators 11 and 36, for example, as shown in FIG. 12, the fuel vapor pressure characteristics different according to the types of the fuels f1 and f2 are specified based on the pressures P1(t1) and P2(t2) at different two points corresponding to the temperatures t1 and t2 at different two points. Consequently, the fuel vapor pressure characteristics related to the types of the fuels f1 and f2 can be correctly estimated. The same applies to the case where the fuel compositions are different.

In this embodiment, furthermore, the estimated fuel vapor pressure characteristics is linearly approximated or curve approximated as shown in FIGS. 8 to 10, so that the gravity of gasoline as fuel can be determined. Furthermore, using the graph in FIG. 11, the concentration of ethanol in ethanol blended gasoline can be estimated.

This embodiment employs the two fuel vapor generators 11 and 36, the two temperature sensors 48 and 52, and the two pressure sensors 47 and 51, so that the temperatures t1 and t2 and pressures P1(t1) and P2(t2) of the fuel vapor at two points can be simultaneously obtained. Consequently, the two temperatures t1 and t2 and the two pressures P1(t1) and P2(t2) of the fuel vapor can be detected in shorter time than in the first embodiment, thereby achieving the reduced time required for estimating the fuel vapor pressure characteristics by just that much. The other operations and advantages related to other configurations of the present embodiment identical to those of the first embodiment are similar to those in the first embodiment.

### Third Embodiment

A third embodiment of a fuel vapor pressure measuring apparatus of the invention applied to a vehicle engine system will be described in detail with reference to an accompanying drawing.

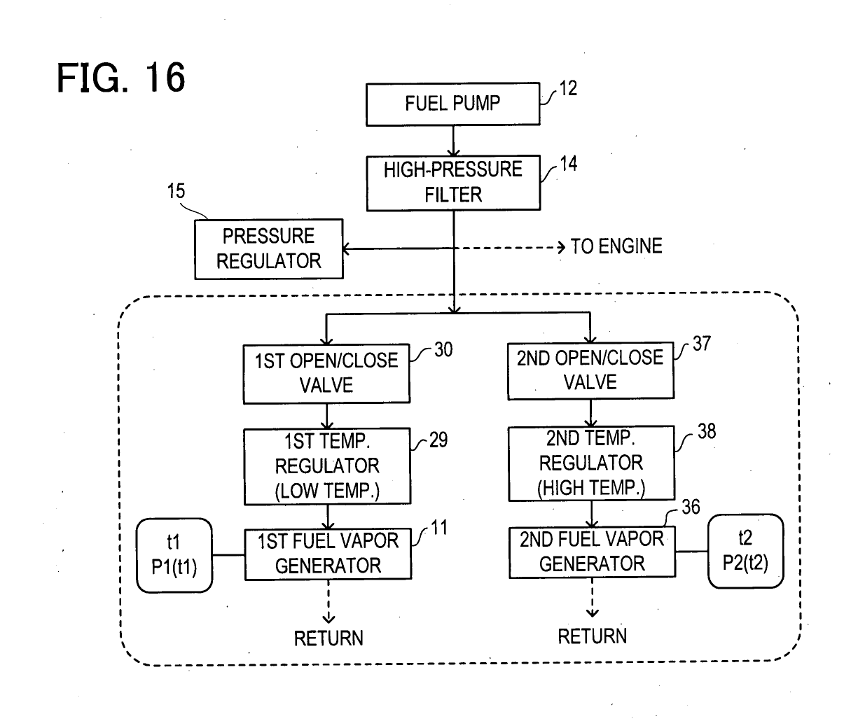

FIG. 16 is a block diagram showing a configuration and others of the fuel vapor pressure measuring apparatus in this embodiment. This embodiment includes double-circuit fuel vapor generators 11 and 36 and is different from the second embodiment in that temperature regulators 29 and 38 are provided in the fuel vapor generators 11 and 36 respectively. Herein, the first temperature regulator 29 in the first fuel vapor generator 11 has a cooling function for low temperature. On the other hand, the second temperature regulator 38 in the second fuel vapor generator 36 has a heating function for high temperature.

In FIG. 16, in this embodiment, the fuel discharged from the fuel pump 12 is filtered by a high-pressure filter 14 and then regulated to a predetermined pressure by a pressure regulator 15. This pressure-regulated fuel is supplied to an engine 1 and also supplied to the double-circuit fuel vapor generators 11 and 36 and others. In a second fuel passage 17 and a branch passage 17a, a first open/close valve 30 and a second open/close valve 37 are provided respectively. While these valves 30 and 37 are closed, the pressure-regulated fuel is not supplied to the fuel vapor generators 11 and 36. When the valves 30 and 37 are opened, in the first fuel vapor generator 11, the pressure-regulated fuel is vaporized under reduced pressure in the vaporizing chamber 26 while the temperature of the fuel is controlled to decrease by the first temperature regulator 29. In the second fuel vapor generator 36, the pressure-regulated fuel is vaporized under reduced pressure in the vaporizing chamber 26 while the temperature of the fuel is controlled to increase by the second temperature regulator 38. At that time, in the first generator 11, the temperature t1 of the fuel vapor in the vaporizing chamber 26 and the pressure P1(t1) of the fuel vapor at the temperature t1 are detected. In the second fuel vapor generator 36, simultaneously, the temperature t2 of the fuel vapor in the vaporizing chamber 26 and the pressure P2(t2) of the fuel vapor at the temperature t2 are detected. Based on those temperatures t1 and t2 and pressures P1(t1) and P2(t2) at two points, the ECU 50 calculates the fuel vapor pressure characteristics. The residual fuel in each fuel vapor generator 11 and 36 is returned to the fuel tank 9. Other configurations are substantially similar to those in the second embodiment.

In this embodiment, consequently, the same operations and advantages as those in the second embodiment can be obtained. In this embodiment, additionally, the first fuel vapor generator 11 includes the first temperature regulator 29 for low temperature and the second fuel vapor generator 36 includes the second temperature regulator 38 for high temperature to set different temperatures t1 and t2. This makes it possible to variably set a temperature difference between the temperatures t1 and t2 at two points as required and also set the temperature difference to “10° C.” or more.

### Fourth Embodiment

A fourth embodiment of a fuel vapor pressure measuring apparatus of the invention applied to a vehicle engine system will be described in detail with reference to accompanying drawings.

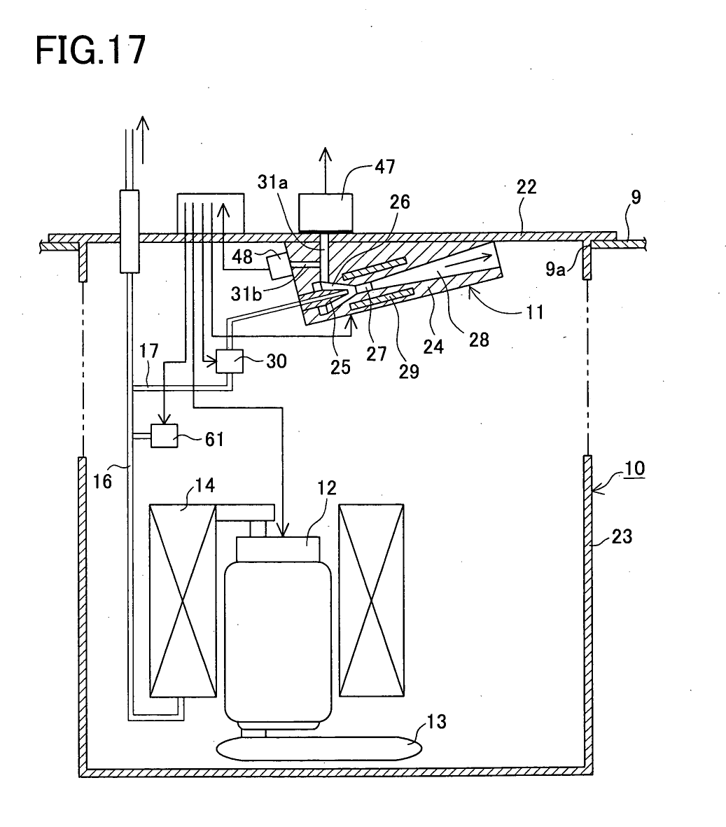

FIG. 17 is a cross sectional view of a main configuration of the fuel vapor pressure measuring apparatus in this embodiment. This embodiment mainly differs from the first embodiment in that the pressure of fuel to be supplied to an engine 1 and a fuel vapor generator 11 is increased as required.

In the first embodiment, the “dynamic vapor pressure method” is adopted to measure the fuel vapor pressure. In such measurement, the suction capability of the vaporizing chamber 26 depends on the flow velocity of fuel injected from the nozzle 25 in the fuel vapor generator 11. Accordingly, the pressure in the vaporizing chamber 26 could not sufficiently be reduced to the fuel vapor pressure according to the flow velocity. Herein, the flow velocity of the fuel injected from the nozzle 25 depends on the pressure of fuel (fuel pressure) to be supplied to the nozzle 25. If such fuel pressure is not sufficiently high, the fuel vapor pressure could not be measured correctly.

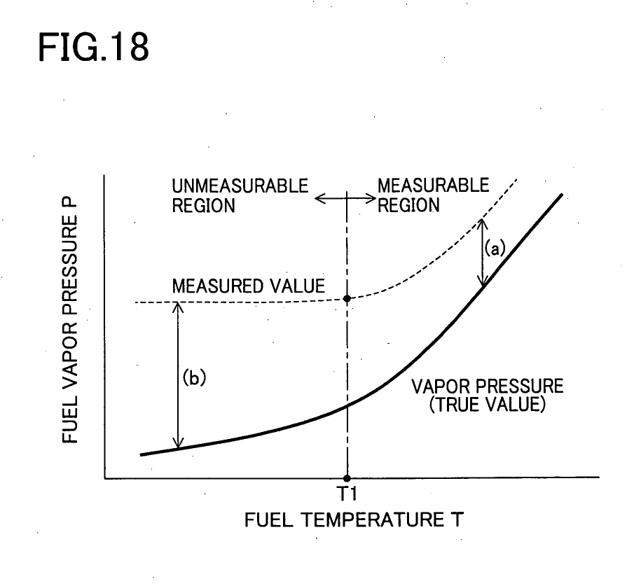

FIG. 18 is a graph showing a relation between the fuel vapor pressure P and fuel temperature T measured in the fuel vapor generator 11, plotting different fuel pressures to be supplied to the nozzle 25. True values of the fuel vapor pressure are indicated by a solid line in FIG. 18. Measured values in the case where the fuel pressure is not sufficiently high are indicated by a broken line in FIG. 18. These measured values form a characteristic curve largely apart from a characteristic curve formed from the true values. In FIG. 18, in the case (a) where the interval in the graph between the true value and the measured value falls within a predetermined range, the measured value can be assumed as the fuel vapor pressure. As this interval is smaller, the measurement accuracy is higher. In the case (b) where the interval between the true value and the measured value is beyond the predetermine range, the measured value cannot be assumed as the fuel vapor pressure. A measurement limit in FIG. 18 corresponds to the time when the fuel temperature is T1. A lower-temperature side than the temperature T1 is an unmeasurable region and a higher-temperature side than the T1 is measurable region. It is conceivable herein that the fuel pressure by the fuel pump 12 is always made high to measure the fuel vapor pressure. In this case, however, the fuel pump 12 has the problems with power consumption and duration of life.

In this embodiment, therefore, the fuel pressure to be supplied to the nozzle 25 is increased only when the fuel vapor pressure is measured by the fuel vapor generator 11. As shown in FIG. 17, the pressure regulator 15 is eliminated from the configuration in the first embodiment and a fuel pressure control section 61 is provided somewhere in a first fuel passage 16. This fuel pressure control section 60 is to increase the pressure of fuel to be pressure fed to the injector 5 and the nozzle 25. In this embodiment, a solenoid valve is used as the fuel pressure control section 61 to change the fuel pressure in a certain range by changing a flow passage area according to an electric current value. The fuel pressure control section 61 is electrically connected to and controlled by the ECU 50. A second fuel passage 17 branches off from the first fuel passage 16 downstream of the fuel pressure control section 61 and is connected to the nozzle 25. The fuel pump 12 in this embodiment is configured to variably control the pressure of discharged fuel by variably controlling the number of motor revolutions.

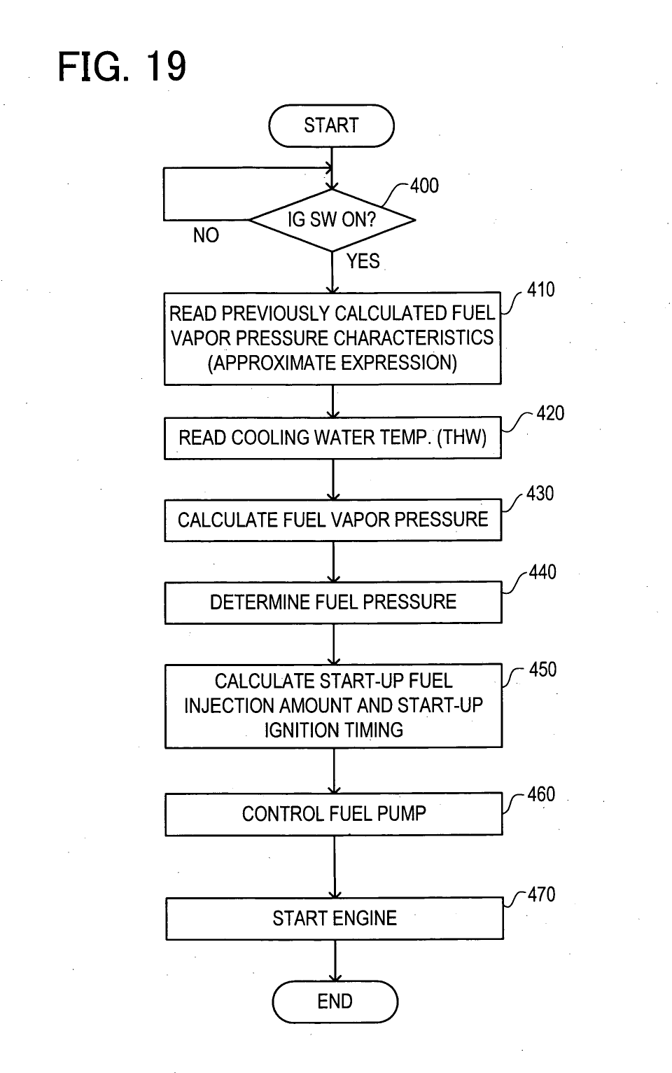

Herein, the details of fuel supply control and ignition timing control at engine start-up are explained. FIG. 19 is a flowchart showing the control details.

In step 400, firstly, an IG switch 46 is turned on. In step 410, the ECU 50 reads the previously calculated fuel vapor pressure characteristics (an approximate expression). This fuel vapor pressure characteristics has been calculated in a previous measurement and written in a RAM of the ECU 50.

In step 420, the ECU 50 reads a cooling water temperature THW based on a detection signal from a water temperature sensor 33. Based on this cooling water temperature THW, a current fuel temperature can be estimated.

In step 430, the ECU 50, referring to the fuel vapor pressure characteristics read in step 410, calculates a current fuel vapor pressure based on the cooling water temperature THW read in step 420. Herein, calculating the fuel vapor pressure based on the cooling water temperature THW is conducted to correctly calculate the vapor pressure of fuel to be injected from the injector 5 at the current fuel temperature.

In step 440, the ECU 50 determines a fuel pressure to be set based on the calculated fuel vapor pressure. The ECU 50 makes this determination by referring to a previously set fuel pressure map.

In step 450, the ECU 50 calculates a fuel injection amount and a ignition timing for start-up respectively based on the calculated fuel vapor pressure. The ECU 50 makes this calculation by referring to a start-up fuel injection amount map and a start-up ignition timing map, both being previously determined. The ECU 50 thus makes a correction to increase the start-up fuel amount and simultaneously a correction of the start-up ignition timing.

In step 460, the ECU 50 controls the fuel pump 12. Herein, the ECU 50 controls the number of motor revolutions of the fuel pump 12 to obtain the fuel pressure determined in step 440.

In step 470, the ECU 50 controls the injector 5 and the igniter 7 based on the fuel injection amount and the ignition timing calculated in step 450 to start the engine 1.

Herein, the fuel pressure is determined in step 440 based on the fuel vapor pressure, so that the following advantages are expected at the start of the engine 1. Specifically, at the low-temperature start-up, the fuel of low vapor pressure is controlled to high fuel pressure, thereby prompting atomization of fuel to be injected from the injector 5. If light fuel (high vapor pressure) is considered as having no problem with ignition property in a combustion chamber 2, the amount of fuel pressure rise is adjusted to restrain power consumption of the fuel pump 12. At the high-temperature start-up, on the other hand, the fuel vapor pressure in the first fuel passage 16 is estimated from the cooling water temperature THW and then the fuel pressure is increased than the vapor pressure, thereby preventing the occurrence of fuel vapor. Controlling the fuel pressure to an appropriate one enables reduction of wasteful power consumption of the fuel pump 12.

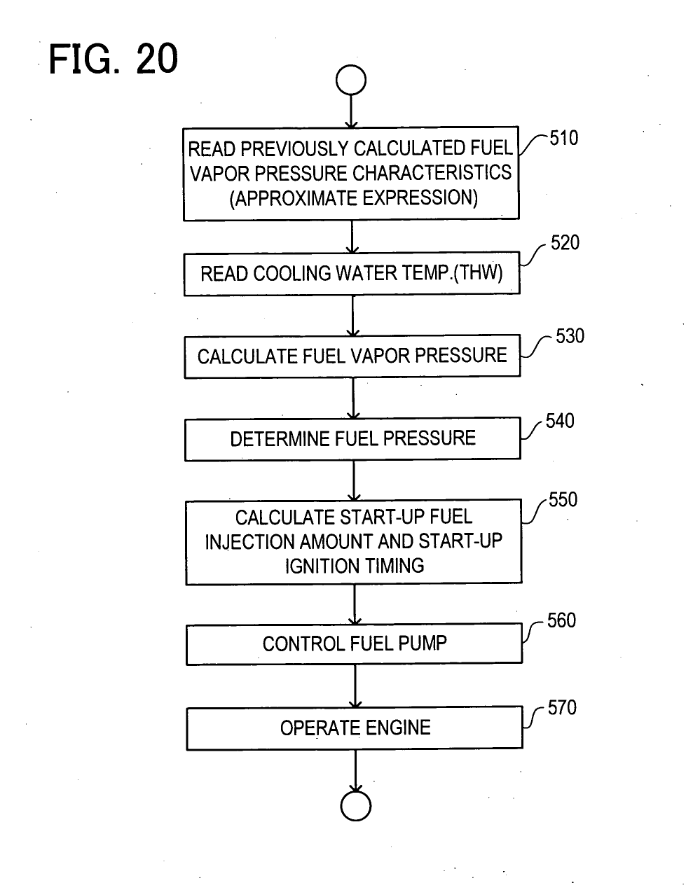

In this embodiment, even during operation after the end of start-up of the engine 1, the ECU 50 calculates the fuel vapor pressure in the same manner as above and determines the fuel pressure to operate the engine 1. FIG. 20 is a flowchart showing the details of fuel supply control and ignition timing control during engine operation. The detailed process in each of steps 510 to 570 in this routine corresponds to the process in each of steps 410 to 470 in the flowchart in FIG. 19.

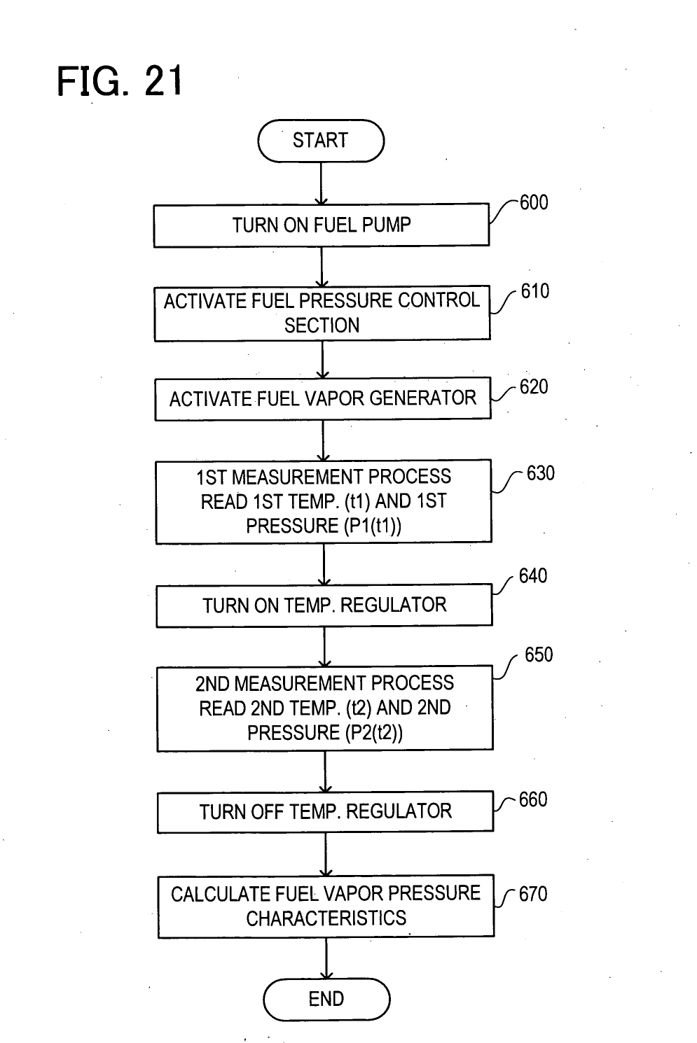

The details of the measurement process of fuel vapor pressure in this embodiment are explained below. FIG. 21 is a flowchart showing the process details. The ECU 50 executes this routine after the end of operation of the engine 1.

In step 600, firstly, the ECU 50 turns on the fuel pump 12. Herein, the fuel pump 12 having been stopped once after the end of operation of the engine 1 is activated again for the measurement process of the fuel vapor pressure.

In step 610, the ECU 50 activates the fuel pressure control section 61. To be concrete, the ECU 50 reduces the flow passage area of the fuel pressure control section 61, thereby increasing the pressure of fuel to be discharged from the fuel pump 12 and be pressure fed to the nozzle 25 and the injector 5 of the fuel vapor generator 11, up to a predetermined value.

In step 620, the ECU 50 activates the fuel vapor generator 11. Specifically, the ECU 50 opens an open/close valve 30 to inject fuel from the nozzle 25. Thus, the fuel injected from the nozzle 25 sticks to a throat 27 and flows at high velocity, thereby sucking the vaporizing chamber 26 to generate negative pressure therein, thus vaporizing the fuel in the vaporizing chamber 26 under reduced pressure.

In step 630, the ECU 50 executes a first measurement process. Specifically, after a lapse of a predetermined time from the start of the process in step 620, the ECU 50 reads, respectively, a first temperature t1 of the fuel vapor detected by the temperature sensor 48 and a first pressure P1(t1) of the fuel vapor detected by the pressure sensor 47 at the same time when the first temperature t1 is detected.

In step 640, the ECU 50 then turns on the temperature regulator 29 to thereby change the temperatures of the vaporizing chamber 26, the throat 27, and a diffuser 28. For instance, the temperatures of those areas 26 to 28 are raised, thereby changing the temperature of the fuel vapor generated in the vaporizing chamber 26.

In step 650, subsequently, the ECU 50 executes a second measurement process. To be concrete, after a lapse of a predetermined time from the start of the process in step 640, the ECU 50 reads, respectively, a second temperature t2 of the fuel vapor detected by the temperature sensor 48 and a second pressure P2(t2) of the fuel vapor detected by the pressure sensor 47 at the same time when the second temperature t2 is detected.

Subsequently, the ECU 50 turns off the temperature regulator 29 in step 660, calculates in step 670 the fuel vapor pressure characteristics (an approximate expression) based on the temperatures t1 and t2 and pressures P1(t1) and P2(t2) measured at two points read in steps 630 and 650, and stores a calculation result in a RAM of the ECU 50.

According to the fuel vapor pressure measuring apparatus in this embodiment described above, the following operations and advantages are provided in addition to those in the first embodiment. Specifically, the fuel, pressure is increased by the fuel pressure control section 61 when the fuel is to be pressure fed to the nozzle 25, thus increasing the flow velocity of fuel injected from the nozzle 25 to the throat 27 and the diffuser 28, increasing a suction force in the vaporizing chamber 26, so that the fuel vapor pressure generated in the vaporizing chamber 26 approximates the true value. This makes it possible to more correctly measure the fuel vapor pressure and additionally estimate the fuel vapor pressure characteristics more precisely.

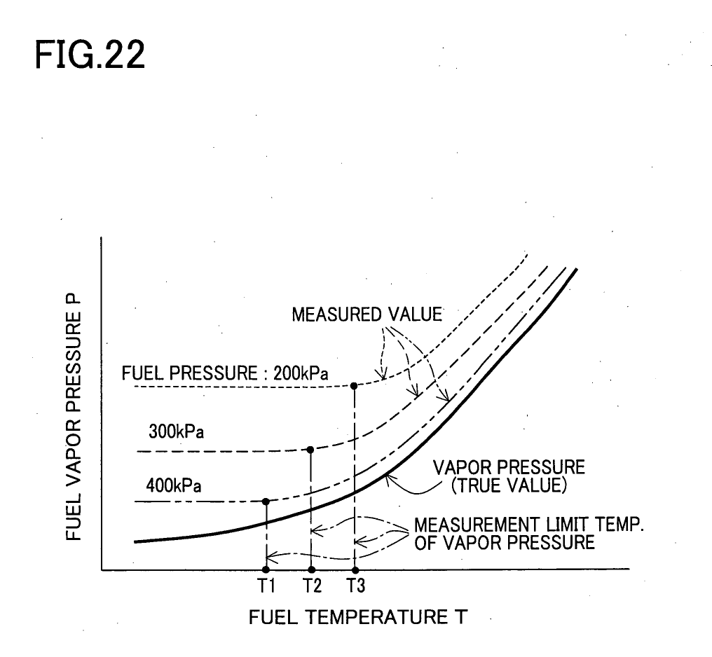

FIG. 22 is a graph showing a relation between the fuel vapor pressure and the fuel temperature measured by the fuel vapor generator 11, plotting different fuel pressures to be supplied to the nozzle 25. As shown in FIG. 22, for example, when the fuel pressure is increased in incremental steps to reach “200 kPa”, “300 kPa”, and “400 kPa”, the characteristic curve formed from measured values of the fuel vapor pressure approximates the characteristic curve formed from true values in stages. This graph reveals that calculation accuracy of the fuel vapor pressure characteristics can be enhanced. As shown in FIG. 22, furthermore, a measurement limit temperature of the fuel vapor pressure is decreased step by step to temperature T3, temperature T2, and temperature T1. This graph also shows that a lower fuel vapor pressure can be measured.

In this embodiment, an appropriate fuel pressure is set based on the measured fuel vapor pressure, so that power consumption of the fuel pump 12 can be reduced. In other words, it is not necessary to constantly enhance the fuel discharging capability of the fuel pump 12. The fuel discharging capability of the fuel pump 12 has only to be enhanced only when the fuel pressure need to be increased, for example, at the time of fuel vapor pressure measurement, engine start-up, and others. It is therefore possible to reduce the power consumption of the fuel pump 12 by just that much.

In this embodiment, the other operations and advantages of the configurations similar to those in the first embodiment are similar to those in the first embodiment.

### Fifth Embodiment

A fifth embodiment of a fuel vapor pressure measuring apparatus of the invention applied to a vehicle engine system will be described in detail with reference to the accompanying drawings.

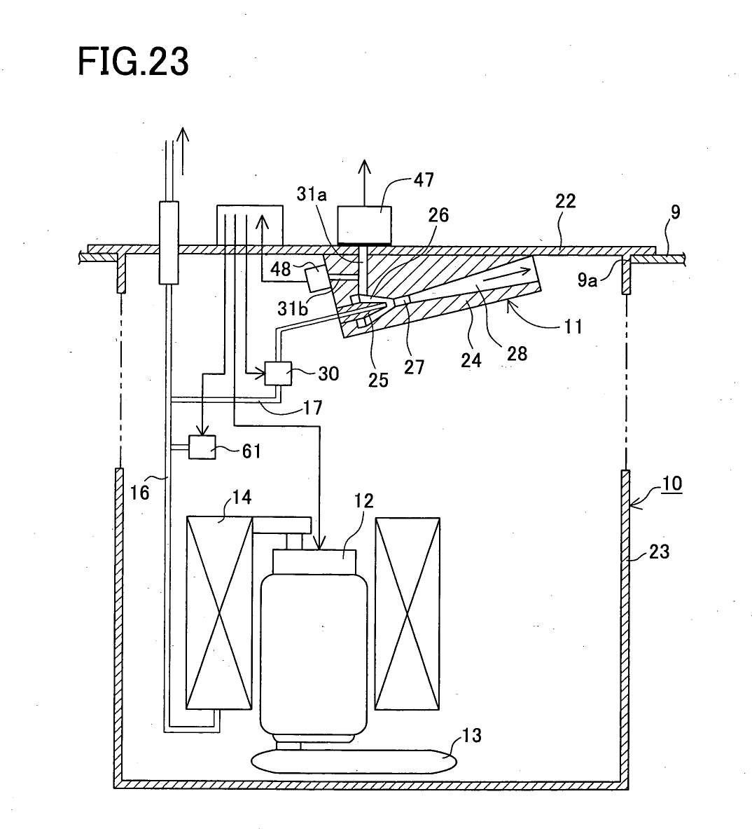

FIG. 23 is a cross sectional view of a main configuration of the fuel vapor pressure measuring apparatus in this embodiment. This embodiment is different from the fourth embodiment in a fuel vapor generator 11 including no temperature regulator 29 and also fuel supply control and ignition timing control at engine start-up.

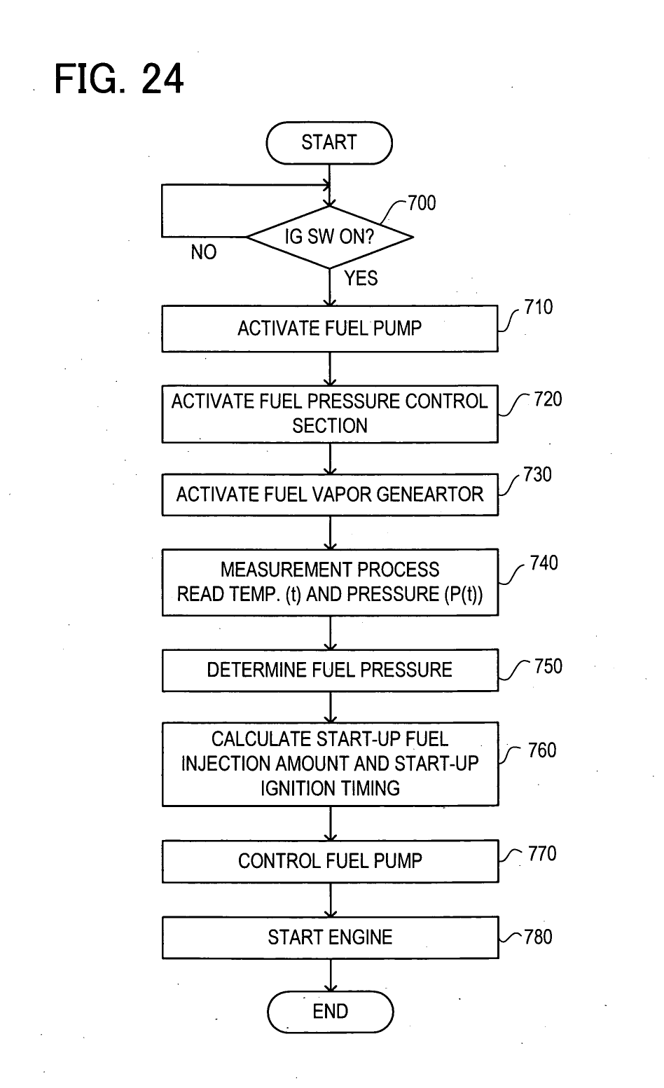

Herein, the details of the fuel supply control and the ignition timing control at the start-up of an engine 1 are explained referring to a flowchart in FIG. 24.

When an IG switch 46 is first turned on in step 700, the ECU 50 starts the fuel pump 12 in step 710.

In step 720, the ECU 50 activates a fuel pressure control section 61. To be specific, the ECU 50 reduces a flow passage area of a solenoid valve to increase the pressure of fuel to be pressure fed to a nozzle 25 and an injector 5 in the fuel vapor generator 11 to a predetermined value.

In step 730, the ECU 50 activates the fuel vapor generator 11. Specifically, the ECU 50 opens an open/close valve 30 to inject the fuel from the nozzle 25. Accordingly, the fuel injected from the nozzle 25 sticks to a throat 27 and flows at high velocity, thereby sucking the vaporizing chamber 26 to generate negative pressure therein. The fuel is thus vaporized under reduced pressure in the vaporizing chamber 26.

In step 740, the ECU 50 executes a measurement process. To be specific, after a lapse of a predetermined time from the start of the process in step 730, the ECU 50 reads, respectively, the temperature t of the fuel vapor detected by a temperature sensor 48 and the pressure P(t) of the fuel vapor detected by a pressure sensor 47 at the same time when the temperature t is detected.

In step 750, the ECU 50 determines a fuel pressure to be set based on the pressure P(t) read in step 740. The ECU 50 makes this determination by referring to a previously determined fuel pressure map.

In step 760, the ECU 50 calculates a start-up fuel injection amount and a start-up ignition timing respectively based on the read pressure P(t). The ECU 50 makes this calculation by referring to a start-up fuel injection amount map and an ignition timing map both being previously determined. Accordingly, the ECU 50 makes a correction to increase the start-up fuel amount and a correction of the start-up ignition timing based on the fuel vapor pressure at the start-up.

In step 770, the ECU 50 controls the fuel pump 12. Herein, the ECU 50 controls the number of motor revolutions of the fuel pump 12 to obtain the fuel pressure determined in step 750.

In step 780, the ECU 50 controls an injector 5 and an igniter 7 based on the fuel injection amount and the ignition timing calculated in step 760 to start the engine 1.

Consequently, in the fuel vapor pressure measuring apparatus in this embodiment, the fuel pressure is increased by the fuel pressure control section 61 at the time of measurement of the fuel vapor pressure. Accordingly, the flow velocity of the fuel injected from the nozzle 25 is increased, enhancing the sucking force in the vaporizing chamber 26, so that the fuel vapor pressure generated in the vaporizing chamber 26 approximates a true value. The measurement accuracy of the fuel vapor pressure can therefore be improved.

Herein, differing from the fourth embodiment, the generator 11 in this embodiment does not include the temperature regulator 29 and hence cannot measure the fuel vapor pressure at different temperatures in short time. However, the detection timing of temperature and pressure of the fuel vapor is changed appropriately, so that the temperatures at different points (time points) and the pressures corresponding thereto can be detected. In this embodiment, accordingly, the temperature and the pressure of the fuel vapor are detected several times to accumulate data on the temperatures and pressures at plural points within a predetermined time. Based on those accumulated data, the fuel vapor pressure characteristics is calculated as in the fourth embodiment. For the fuel vapor generated in the vaporizing chamber 26, consequently, the fuel vapor pressure characteristics different by fuel type can be specified based on a relation between the temperature and the pressure under a predetermined condition.

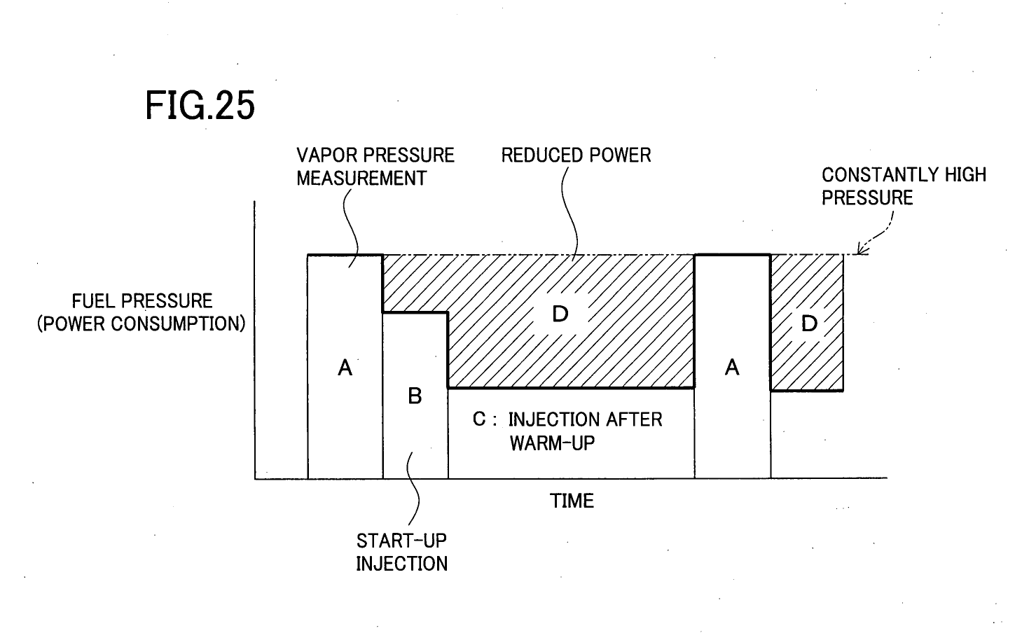

FIG. 25 is a flowchart showing changes in fuel pressure from the engine start in this embodiment. A difference in fuel pressure level correlates with an amount of power consumption of the fuel pump 12. As shown in FIG. 25, during engine start-up, the fuel pressure is first increased to the maximum for a period A for measuring the fuel vapor pressure, the fuel pressure is slightly decreased for a period B for start-up injection, and then the fuel pressure is reduced to a standard value (about 40% of the fuel pressure for the period A) for a period C for injection after warm-up. Thereafter, when the fuel vapor pressure is to be measured in the process of injection after warm-up, the fuel pressure is increased again to the maximum for a second period A. For measurement of the fuel vapor pressure, accordingly, if the fuel pressure is initially set and kept at a high level as shown by a chain double-dashed line in FIG. 25, the fuel pressure is more increased by a region D indicated by hatching as compared with fuel pressure changes in this embodiment indicated by a solid line in FIG. 25. According to this embodiment, consequently, it is found that the power consumption of the fuel pump 12 can be reduced by the region D.

The present invention is not limited to the above embodiments and may be embodied in other specific forms without departing from the essential characteristics thereof.

In the first to fourth embodiments, the pressures P1(t1) and P2(t2) of the fuel vapor corresponding to the temperatures t1 and t2 at two points are measured. Alternatively, temperatures at three or more points and corresponding pressures may be measured. That is, the “plural points” are not limited to two points.

In the first to fourth embodiments, the fuel vapor pressure measurement process is executed after the end of operation of the engine 1. Alternatively, the fuel vapor pressure measurement process may be conducted anytime during operation of the fuel pump 12.

In the above embodiments, the temperature sensors 48 and 52 are placed with respect to the temperature hole 31b communicating with the vaporizing chamber 26 in the body 24 but they may be placed near and upstream of the nozzle 25. In the case where each temperature sensor is placed with respect to the temperature hole 31b as in the above embodiments, each temperature sensor can detect the temperature of fuel vapor more correctly. On the other hand, the temperature sensor placed near and upstream of the nozzle 25 can detect the temperature in shorter time.

In the first to fourth embodiments, the temperature regulator 29 is placed in the body 24 around the vaporizing chamber 26, the throat 27, and the diffuser 28 but may be placed near and upstream of the nozzle 25. The temperature regulator placed in the body 24 around the vaporizing chamber 26, the throat 27, and the diffuser 28 as in the first to fourth embodiments can perform more correct temperature control. However, even the temperature regulator placed near and upstream of the nozzle 25 can conduct temperature control efficiently.

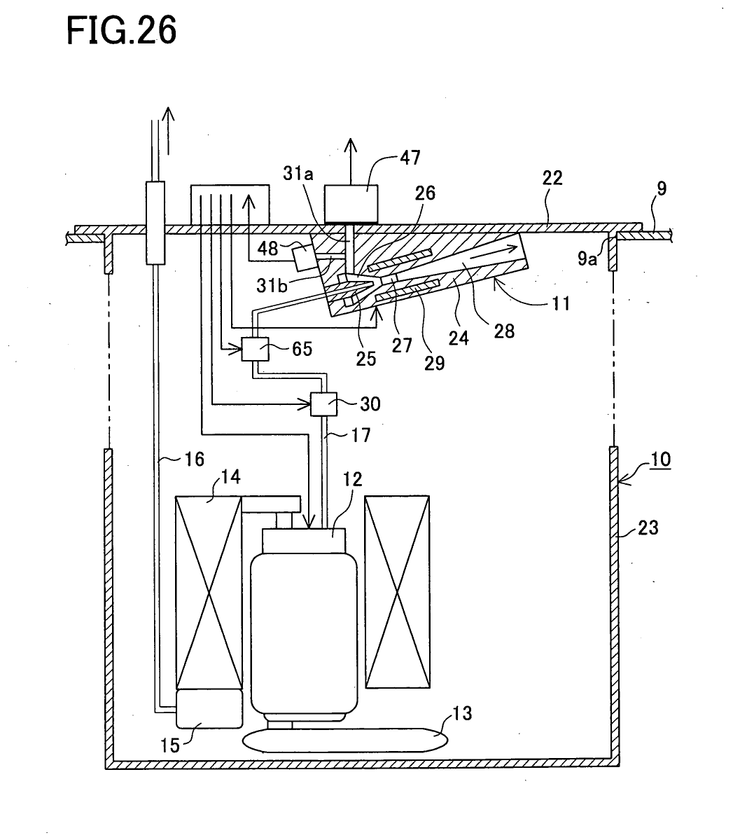

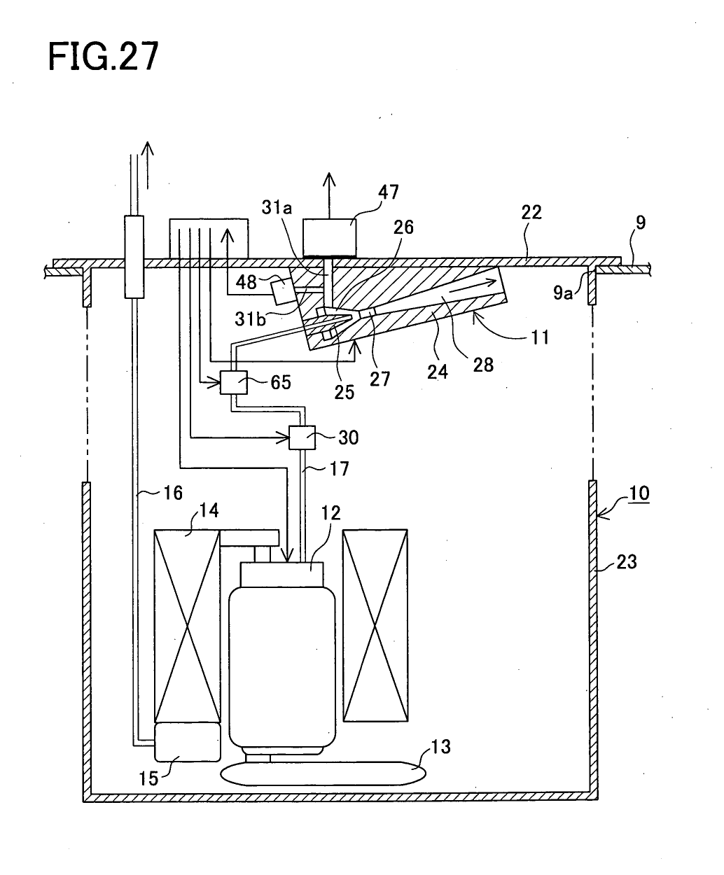

In the first to fourth embodiments, the temperature regulator 29 is placed in the body 24 only around the vaporizing chamber 26, the throat 27, and the diffuser 28. Alternatively, as illustrated in FIG. 26 showing a cross sectional view of a main configuration of a fuel vapor pressure measuring apparatus, it may provide the temperature regulator 29 in the body 24 and additionally provide another temperature regulator 65 in a second fuel passage 17 downstream of an open/close valve 30. Further alternatively, as illustrated in FIG. 27 showing a cross sectional view of a main configuration of a fuel vapor pressure measuring apparatus, it may provide no temperature regulator 29 in a body 24 but provide a temperature regulator 65 in a second fuel passage 17 downstream of an open/close valve 30.

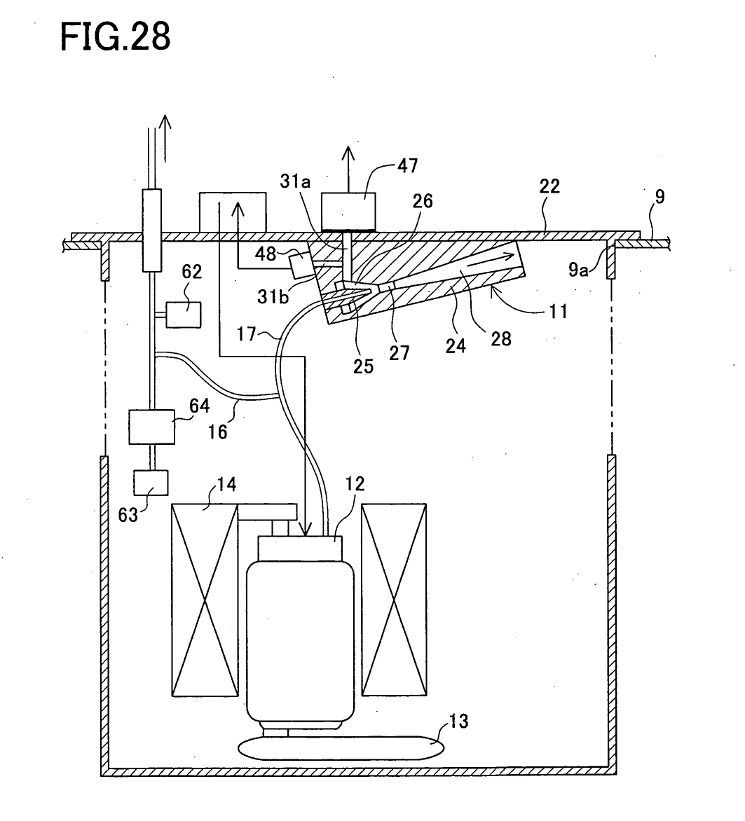

In the fifth embodiment, the pressure control section 61 for changing the fuel pressure in a certain range is provided in the first fuel passage 16. Alternatively, as illustrated in FIG. 28 showing a cross sectional view of a main configuration of a fuel vapor pressure measuring apparatus, it may be arranged such that a fuel pressure regulator for high pressure 62, a fuel pressure regulator for low pressure 63, and a switching valve 64 for switching between the regulators 62 and 63 in use are placed in the first fuel passage 16 so that two fuel pressures, high pressure and low pressure, are switched by the switching valve 64.

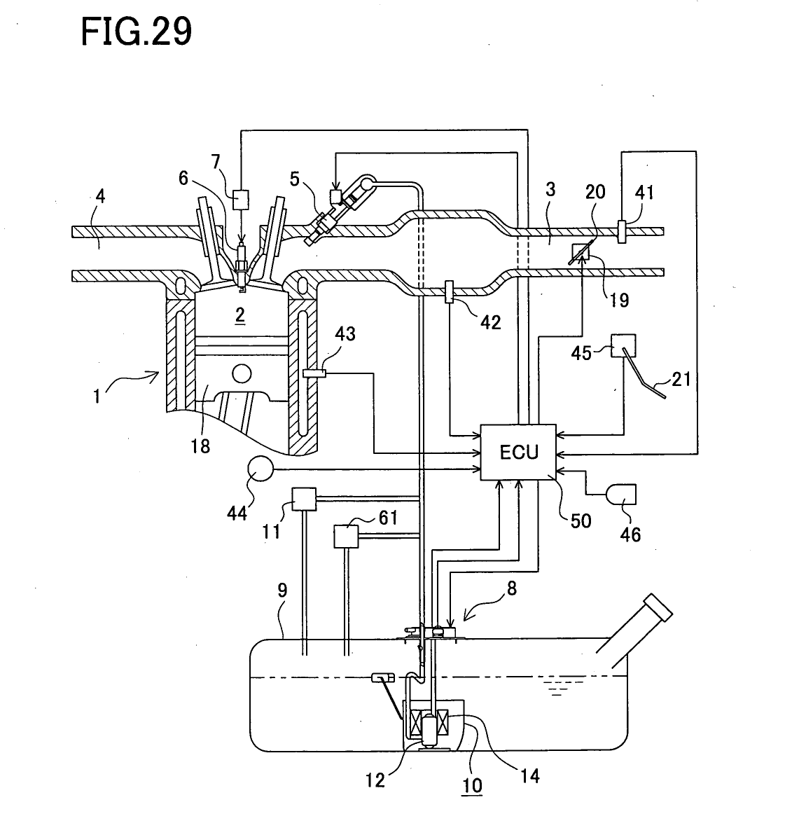

In the above embodiments, the fuel vapor generators 11 and 36 and the pressure control section 61 are placed in the fuel tank 9. Alternatively, the fuel vapor generator 11 and the fuel pressure control section 61 may be placed outside the fuel tank 9 as illustrated in FIG. 29 showing a schematic configuration view of an engine system.

In the above embodiments, the fuel vapor pressure and the fuel vapor pressure characteristics measured and estimated by the fuel vapor measuring apparatus of the invention are reflected to the fuel supply control and the ignition timing control of the engine 1. On the other hand, in an engine including a vapor fuel processing device containing a canister, fuel vapor pressure characteristics of fuel to be used is estimated to estimate a generation amount of vapor fuel (evaporation) (canister adsorbing amount), thereby determining a purge amount of vaporizing fuel from the canister to the engine according to the canister adsorbing amount. Alternatively, when the fuel vapor pressure characteristics estimated by the fuel vapor measuring apparatus is greatly beyond a predetermined range, it is judged that inferior fuel is mixed in the fuel tank and accordingly an alarm is generated to inform a driver thereof.

### INDUSTRIAL APPLICABILITY

The present invention can be used for a fuel supply apparatus for supplying fuel to an internal combustion engine.

While the presently preferred embodiment of the present invention has been shown and described, it is to be understood that this disclosure is for the purpose of illustration and that various changes and modifications may be made without departing from the scope of the invention as set forth in the appended claims.

### REFERENCE SIGNS LIST

9 Fuel tank
10 Fuel pump unit
11 Fuel vapor generator, First vapor generator
12 Fuel pump
25 Nozzle
26 Vaporizing chamber
27 Throat
28 Diffuser
29 Temperature regulator, First temperature regulator
36 Second fuel vapor generator
38 Second temperature regulator
47 Pressure sensor
48 Temperature sensor
50 ECU
51 Pressure sensor
52 Temperature sensor
61 Fuel pressure control section
62 Fuel pressure regulator for high pressure
63 Fuel pressure regulator for low pressure
65 Temperature regulator

1. A fuel vapor pressure measuring apparatus comprising:
a fuel pump for pressure feeding fuel;
a fuel vapor generating section including a nozzle, a venturi, and a vaporizing chamber provided around the nozzle, the fuel vapor generating section being configured to allow the fuel pressure-fed from the fuel pump to be injected from the nozzle and pass through the venturi, thereby vaporizing the fuel in the vaporizing chamber;
a pressure detecting section for detecting pressure of fuel vapor in the vaporizing chamber of the fuel vapor generating section;
a temperature detecting section for detecting temperature of the fuel vapor in the vaporizing chamber of the fuel vapor generating section;
a temperature regulating section for regulating the temperature of the fuel vapor in the vaporizing chamber of the fuel vapor generating section; and
a fuel vapor pressure characteristics calculating section adapted to operate the fuel pump and the fuel vapor generating section and also operate the temperature regulating section, to detect temperatures at plural points through the temperature detecting section and detect pressures corresponding to the temperatures at the plural points through the pressure detecting section in the process of operation of the temperature regulating section, and to calculate fuel vapor pressure characteristics based on the detected temperatures and pressures at the plural points.

2. The fuel vapor pressure measuring apparatus according to claim 1 further comprising a fuel tank for storing the fuel,
the fuel pump and the fuel vapor generating section being placed in the fuel tank.

3. The fuel vapor pressure measuring apparatus according to claim 2 further comprising:
a fuel passage extending from the fuel pump and connected to the nozzle of the fuel vapor generating section; and
an open/close valve for selectively interrupting flow of the fuel in the fuel passage.

4. The fuel vapor pressure measuring apparatus according to claim 3, wherein
the temperature regulating section is placed in the fuel passage downstream of the open/close valve.

5. The fuel vapor pressure measuring apparatus according to claim 2, wherein
the fuel vapor generating section includes a body, the body being provided with the nozzle, the vaporizing chamber provided around the nozzle, the venturi communicating with the vaporizing chamber, and the temperature regulating section placed around the vaporizing chamber and the venturi.

6. The fuel vapor pressure measuring apparatus according to claim 3, wherein
the fuel vapor generating section includes a body, the body being provided with the nozzle, the vaporizing chamber provided around the nozzle, the venturi communicating with the vaporizing chamber, and the temperature regulating section placed around the vaporizing chamber and the venturi.

7. The fuel vapor pressure measuring apparatus according to claim 5 further comprising:
a fuel passage extending from the fuel pump and connected to the nozzle of the fuel vapor generating section;
an open/close valve for selectively interrupting flow of the fuel in the fuel passage; and
another temperature regulating section placed in the fuel passage downstream of the open/close valve.

8. The fuel vapor pressure measuring apparatus according to claim 1 further comprising a fuel pressure changing section for increasing the pressure of fuel to be pressure fed to the nozzle of the fuel vapor generating section.

9. A fuel vapor pressure measuring apparatus comprising:
a fuel pump for pressure feeding fuel;
a plurality of fuel vapor generating sections each including a nozzle, a venturi, and a vaporizing chamber provided around the nozzle, each fuel vapor generating section being configured to allow the fuel pressure-fed from the fuel pump to be injected from the nozzle and pass through the venturi, thereby vaporizing the fuel in the vaporizing chamber;
pressure detecting sections for detecting pressures of fuel vapor in the vaporizing chambers of the fuel vapor generating sections;
temperature detecting sections for detecting temperatures of the fuel vapor in the vaporizing chambers of the fuel vapor generating sections;
a temperature regulating section for regulating the temperature of the fuel vapor in the vaporizing chamber of at least one of the fuel vapor generating sections; and
a fuel vapor pressure characteristics calculating section adapted to operate the fuel pump and the fuel vapor generating sections and also operate the temperature regulating sections, to detect the temperatures at plural points through the temperature detecting sections and detect the pressures corresponding to the temperatures at the plural points through the pressure detecting sections in the process of operation of the temperature regulating section, and to calculate fuel vapor pressure characteristics based on the detected temperatures and pressures at the plural points.

10. The fuel vapor pressure measuring apparatus according to claim 9 further comprising a first fuel vapor generating section and a second fuel vapor generating section, the temperature regulating section being provided in only the first fuel vapor generating section.

11. The fuel vapor pressure measuring apparatus according to claim 9 further comprising a fuel tank for storing the fuel,
the fuel pump and the fuel vapor generating sections being placed in the fuel tank.

12. The fuel vapor pressure measuring apparatus according to claim 10 further comprising a fuel tank for storing the fuel,
the fuel pump and the first and second fuel vapor generating sections being placed in the fuel tank.

13. The fuel vapor pressure measuring apparatus according to claim 12 further comprising:
a fuel passage extending from the fuel pump and connected to the nozzles of the first and second fuel vapor generating sections; and
an open/close valve for selectively interrupting flow of the fuel in the fuel passage.

14. The fuel vapor pressure measuring apparatus according to claim 12, wherein
the first and second fuel vapor generating sections include bodies respectively, each of the bodies being provided with the nozzle, the vaporizing chamber provided around the nozzle, and the venturi communicating with the vaporizing chamber, and the body of the first fuel vapor generating section being provided with the temperature regulating section placed around the vaporizing chamber and the venturi.

15. The fuel vapor pressure measuring apparatus according to claim 11 further comprising a fuel pressure changing section for increasing the pressure of fuel to be pressure fed to the nozzles of the fuel vapor generating sections.

16. A fuel vapor pressure measuring apparatus comprising:
a fuel pump for pressure feeding fuel;
a fuel vapor generating section including a nozzle, a venturi, and a vaporizing chamber provided around the nozzle, the fuel vapor generating section being configured to allow the fuel pressure-fed from the fuel pump to be injected from the nozzle and pass through the venturi, thereby vaporizing the fuel in the vaporizing chamber;
a pressure detecting section for detecting pressure of fuel vapor in the vaporizing chamber of the fuel vapor generating section;
a temperature detecting section for detecting temperature of the fuel vapor in the vaporizing chamber of the fuel vapor generating section;
a fuel pressure changing section for increasing pressure of the fuel to be pressure-fed to the nozzle of the fuel vapor generating section; and
a fuel vapor pressure characteristics calculating section adapted to operate the fuel pump and the fuel vapor generating section and also operate the fuel pressure changing section, to detect the temperature several times through the temperature detecting section and detect the pressure several times through the pressure detecting section in the process of operation of the fuel pressure changing section, and to calculate fuel vapor pressure characteristics based on the detected temperatures and pressures at the plural points.

17. The fuel vapor pressure measuring apparatus according to claim 16 further comprising a fuel tank for storing the fuel,
the fuel pump and the fuel vapor generating section being placed in the fuel tank.

18. The fuel vapor pressure measuring apparatus according to claim 17 further comprising:
a fuel passage extending from the fuel pump and connected to the nozzle of the fuel vapor generating section; and
an open/close valve for selectively interrupting flow of the fuel in the fuel passage.

19. The fuel vapor pressure measuring apparatus according to claim 18, wherein
the temperature regulating section is placed in the fuel passage downstream of the open/close valve.

20. The fuel vapor pressure measuring apparatus according to claim 17 further comprising a fuel passage extending from the fuel pump and connected to the nozzle of the fuel vapor generating section,
the fuel pressure changing section including a fuel pressure regulator for high pressure, a fuel pressure regulator for low pressure, and a switching valve for switching between the two fuel pressure regulators,
the switching valve being adapted to switch between the two fuel pressure regulators to switch the pressure of fuel to be supplied from the fuel pump to the fuel passage between two high and low pressures.
